(19) United States
(12) Patent Application Publication
(10) Pub. No.: US 2025/0286114 A1
(43) Pub. Date: Sep. 11, 2025

(54) ELECTROLYTE COMPOSITION FOR OPERATING LI-ION BATTERY CELLS AT HIGH TEMPERATURE

(71) Applicant: Wayne State University, Detroit, MI (US)

(72) Inventors: Sudhan Nagarajan, Detroit, MI (US); Leela Mohana Reddy Arava, Troy, MI (US)

(21) Appl. No.: 19/072,090

(22) Filed: Mar. 6, 2025

Related U.S. Application Data
(60) Provisional application No. 63/563,176, filed on Mar. 8, 2024.

(51) Int. Cl. H01M 10/0525; H01M 10/0567; H01M 10/0568; H01M 10/0569; H01M 50/417; H01M 50/434; H01M 50/449

(52) U.S. Cl. CPC H01M 10/0525; H01M 10/0567; H01M 10/0568; H01M 10/0569; H01M 50/417; H01M 50/434; H01M 50/449; H01M 2300/002

(57) ABSTRACT

A high temperature rechargeable lithium-ion battery featuring a nonflammable electrolyte composed of a thermally and electrochemically stable ionic liquid, a lithium conducting salt, and a cathode film forming additive. The battery includes a cathode and an anode and is capable of operating at temperatures up to 100° C. and beyond. The ionic liquid may include a phosphonium ionic liquid, and the lithium conducting salt can be selected from various compounds such as lithium bis(trifluoromethanesulfonyl)imide (LiTFSI) and others. Additionally, the cathode film forming additive may comprise lithium difluoro(oxalato)borate (LiDFOB). The cathode may be composed of LiNiₓMn_{y}CO_{z}O₂, and the anode may include Li₄Ti₅O₁₂ (LTO). The battery is also operable at temperatures up to 125° C.

### CROSS-REFERENCE TO RELATED APPLICATIONS

This application claims the benefit of and priority to U.S. Provisional Application No. 63/563,176 filed on Mar. 8, 2024, the contents of which is incorporated herein by reference in its entirety.

### STATEMENT REGARDING FEDERALLY SPONSORED RESEARCH AND DEVELOPMENT

This invention was made with government support under NSF 2127519 and NSF 1751472 awarded by NATIONAL SCIENCE FOUNDATION. The government has certain rights in the invention.

### TECHNICAL FIELD

Exemplary fields of technology for the present disclosure relate to a rechargeable battery, and particularly to an electrolyte composition for operating Li-ion battery cells at high temperature.

### BACKGROUND

Beyond portable electronics, Li-ion batteries are being adapted to various technological applications such as electric vehicles and stationary applications. In most of the operation and storage conditions, the Li-ion battery needs to be physically as well as chemically stable to avoid unintended safety issues such as excessive heating and risks of fires. To ensure safe battery operation, it is of paramount importance to develop Li-ion batteries using non-flammable materials. Fundamentally, the high temperature Li-ion battery is mainly dependent on the electrolyte and electrode components and their stability of interfacial reactions during high temperature operations. In a majority of the commercial Li-ion batteries, the electrolyte component is flammable organic carbonate electrolyte materials such as ethylene carbonate (EC), dimethyl carbonate (DMC), propylene carbonate (PC) and ethyl methyl carbonate (EMC). When considering flammability concerns, organic carbonate electrolytes are, therefore, not a viable option as they are quite volatile and flammable, leading to irreversible degradation such as fires and explosions. Conversely, room temperature ionic liquids (RTIL) are interesting alternatives due to their excellent properties such as non-flammability, negligible vapor pressure, ionic conductivity, and thermal and electrochemical stability. Ionic liquids have shown promise at room temperature and moderate temperature applications, but research is lacking thus far for high temperature applications.

Recent studies have investigated the interaction between a model NMC333 cathode and a pyrrolidinium-based ionic liquid at an extreme operating temperature of 100° C. These studies found that the CEI effectively stabilized the reactive cathode surface by forming a robust interphase layer, reducing direct contact between the electrolyte and NMC cathode particles. Furthermore, the findings indicate that thermal stability and electrochemical interfacial stability are independent factors, despite the ionic liquid exhibiting high thermal stability beyond the operating temperature. This confirms that degradation primarily originates at the electrode-electrolyte interface.

In general, electrode-electrolyte interfacial reactions are crucial to achieve electrochemical performance from the electrode materials. The interfacial stability is heavily affected when the battery is operated in an extreme environment. The high temperature operation accelerates parasitic reactions, leading to structural heterogeneities between the surface and bulk of the electrode materials. The degradation phenomena can occur in numerous ways, especially the formation of surface reconstruction with multiple phases that are different from the bulk of the material. To date, various experimental investigations have been attempted to understand depth-dependent electronic structure evolution and interfacial reaction mechanisms using various synchrotron spectroscopy and advanced microscopy probes for cathodes cycled in carbonate electrolytes.

Investigations into the thermal stability of lithium salts at high temperatures have shown that prolonged aging can lead to salt degradation, which promotes transition metal reduction. Additionally, studies utilizing X-ray diffraction, absorption, and X-ray Raman spectroscopies have identified thermal stress-induced charge heterogeneities, revealing bulk and surface phase changes during delithiation at elevated temperatures. Depth-probing analysis with soft and hard X-ray spectroscopy has further examined NMC811 cathodes, demonstrating how lithium extraction affects the surface-to-bulk valence state variation of Ni redox, even at room temperature.

Even though the interfacial reaction mechanisms of cathode materials have been investigated, the investigation focused on room temperature and slightly above room temperature up to 60° C. More importantly, the studies investigated majorly organic carbonate electrolyte configurations. Alternative to carbonate electrolytes, the ionic liquid is the choice for developing nonflammable Li-ion batteries but the ionic liquid electrolyte stability with high temperature operation is not well understood. Even though ionic liquids are thermally stable at high temperatures compared to the state of the carbonate electrolytes, the electrochemical stability at high temperatures is not well understood even for state-of-the-art cathodes.

To develop nonflammable extreme temperature Li-ion batteries, understanding the reaction mechanisms of nonflammable ionic liquid interaction with state-of-the-art cathode materials is of paramount importance. To date, there has been limited attention dedicated to the effect of electrode-electrolyte interfacial reactivity even in carbonate electrolytes, but ionic liquid interaction with oxide cathode is completely unclear. With this knowledge gap in high temperature batteries, extensive investigation is needed to elucidate the surface and bulk electronic structure and interfacial reaction mechanisms of cathodes in extreme environments with non-flammable ionic liquid electrolytes.

In view of the problems and limitations of conventional batteries, there is a need for improved battery technology that not only offers rechargeability but also maintains stability and safety at high temperatures.

According to the present disclosure, there is provided a high temperature rechargeable lithium-ion battery and method of making the same, as set forth in the appended claims.

### SUMMARY

The present disclosure relates to a high-temperature rechargeable lithium-ion battery that incorporates a nonflammable electrolyte. The nonflammable electrolyte includes a thermally and electrochemically stable ionic liquid, a lithium-conducting salt, and a film-forming additive. The battery includes a cathode and an anode and is capable of operating at temperatures of 100° C. and beyond, with some aspects supporting operation up to 125° C.

In some implementations, the nonflammable electrolyte includes a phosphonium-based ionic liquid to enhance thermal and electrochemical stability. The lithium-conducting salt may be selected from lithium bis(trifluoromethanesulfonyl)imide (LiTFSI), lithium perchlorate (LiClO₄), lithium bis(fluorosulfonyl)imide (LiFSI), lithium bis(oxalato)borate (LiBOB), 4,5-dicyano-2-(trifluoromethyl)imidazolide (LiTDI), or lithium tetrafluoroborate (LiBF₄). Additionally, a film-forming additive, such as, for example, lithium difluoro(oxalato)borate (LiDFOB), may be included to promote a stable solid electrolyte interphase (SEI) and cathode electrolyte interphase (CEI), reducing degradation and improving cycling performance at elevated temperatures.

In some implementations, the cathode material may include LiNixMnyCozO2 (NMC), where x+y+z=1, offering an optimal balance of high energy density, thermal stability, and electrochemical performance. The anode may incorporate Li₄Ti₅O₁₂ (LTO), which provides excellent structural stability, a relatively high operating voltage to mitigate lithium dendrite formation, and extended cycle life under elevated temperature conditions.

Further, a method for manufacturing the high-temperature rechargeable lithium-ion battery is disclosed. The method includes providing a nonflammable electrolyte, a cathode, and an anode, and assembling the components into a functional battery capable of sustained operation at elevated temperatures. The electrolyte composition can be tailored with different phosphonium-based ionic liquids, lithium-conducting salts, and film-forming additives to optimize performance for specific applications.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

Aspects of the present disclosure are illustrated by way of example and are not limited by the accompanying figures for which like references indicate like elements.

FIG. 1 is a schematic illustration of a high temperature lithium-ion battery according to the disclosure.

FIG. 2 is a digital image showing the double side coated electrodes compared with the scale bar of a ruler in inch scale.

FIG. 3A is a digital image of rolled electrodes and separators in an ungrooved cylindrical cell.

FIG. 3B is a digital image of a cylindrical lithium-ion battery cell, with its top cover partially open, and fully assembled with the cover sealed.

FIG. 4 is a schematic representation of depth-dependent probing modes in the cathode particle and a structure of an ionic liquid phosphonium cation (tributyl methyl phosphonium) and Bis(trifluoro methane sulfonamide) TFSI anion.

FIGS. 5A-5F illustrate the electrochemical voltage profiles of the NMC532 cathode cycled in a phosphonium-based ionic liquid electrolyte at 100° C.

FIGS. 6A-6D show the pre-edge spectra of Ni, Co, and Mn using X-ray Absorption Near Edge Structure (XANES) spectroscopy.

FIGS. 7A-7B show soft X-ray absorption spectroscopy measurements of the Ni and Co elements of NMC532 cathode electrochemically cycled at different conditions.

FIG. 8A shows the relative intensity ratio between L3 high energy peak to low energy peak at different cycling conditions depth-dependent detection modes (PEY, TEY, and FY).

FIG. 8B shows Mn L-edge soft XAS spectra of NMC532 electrode at different cycling conditions.

FIGS. 9A-9C show soft XAS O K edge spectra of NMC532 cathode at different sample conditions and standard samples.

FIGS. 10A-10B show O 1 s HAXPES spectra of NMC532 cathode cycled at different cycling conditions and photon energies of (a) 2000 eV and (b) 4000 eV.

FIGS. 11A-11B show S 1 s and P 1 s HAXPES spectra of NMC532 cathode at different cycled conditions.

FIGS. 12A-12C show C 1 s HAXPES spectra of NMC532 cathode at different cycled conditions.

FIGS. 13A-13B show B 1 s HAXPES spectra of NMC532 cathode two different cycling conditions.

FIGS. 14A-14H show various High-Angle Annular Dark Field-Scanning Transmission Electron Microscopy (HAADF-STEM) imaging of the NMC532 cathode.

FIG. 15 illustrates a cation disordering process that affects the Li intercalation, diffusivity, and surface layer buildup.

FIGS. 16A-16B show the electrochemical behavior of the NMC532 cathode and LTO full cell in a 14500 cell.

FIG. 16C shows the voltage profiles of an AA cell with the chemistry of the present disclosure operated at 125° C.

FIG. 17 is a flowchart showing a method of forming a rechargeable high temperature nonflammable lithium-ion battery.

### DESCRIPTION

Referring now to the discussion that follows and the drawings, illustrative approaches to the disclosed systems and methods are described in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive, otherwise limit, or restrict the claims to the precise forms and configurations shown in the drawings and disclosed in the following detailed description.

This disclosure relates to a technology enabling Li-ion batteries to operate at temperatures beyond 100° C. and up to at least 125° C. According to an aspect, there is disclosed a high temperature cell chemistry combination with nonflammable electrolyte for rechargeable Li-ion batteries using ionic liquid with additives and high temperature compatible lithium conducting salt. The high temperature operation was achieved through a unique electrolyte combination of phosphonium ionic liquid with one or more Li conducting salt and one or more additives.

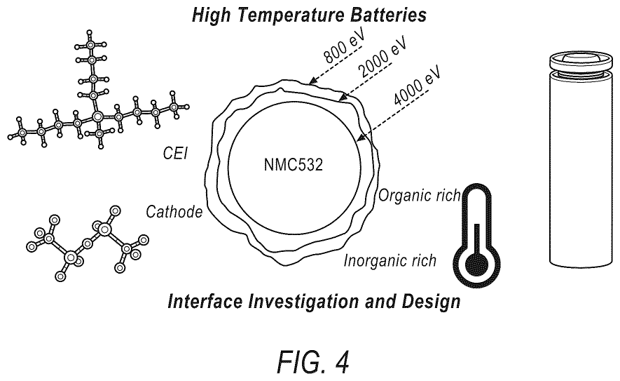

Pursuant to an implementation, the disclosed high-temperature rechargeable lithium-ion battery includes a unique combination of electrolyte composition and cell chemistry. This was achieved in part by evaluating a moderate Ni-content NMC532 cathode paired with a thermally stable tributyl methyl bis(trifluoromethanesulfonyl) imide (Ph1444 TFSI)-based electrolyte, incorporating 0.5 mol/L lithium bis(trifluoromethanesulfonyl) imide (LiTFSI) and 0.5 w/v % lithium difluorooxalato borate (LiDFOB) as a film-forming additive. To assess electrochemical stability and charge heterogeneities at elevated temperatures, multimodal characterization techniques including, for example, hard and soft X-ray spectroscopy, were employed, and various results are shown in FIGS. 4, 5A-5F, 6A-6D, 7A-7B, 8A-8B, 9A-9C, 10A-10B, 11A-11B, 12A-12C, 13A-13B, 14A-14H, 15, and 16A-16B. Additionally, atomic-resolution HAADF-STEM imaging provided direct visualization of surface degradation. These findings guided the development of a high-temperature, non-flammable lithium-ion battery capable of sustained operation up to 125° C. A comprehensive investigation of interfacial electronic structures and CEI formation under high-temperature electrochemical conditions laid the foundation for advancing Li-ion batteries for extreme operating environments.

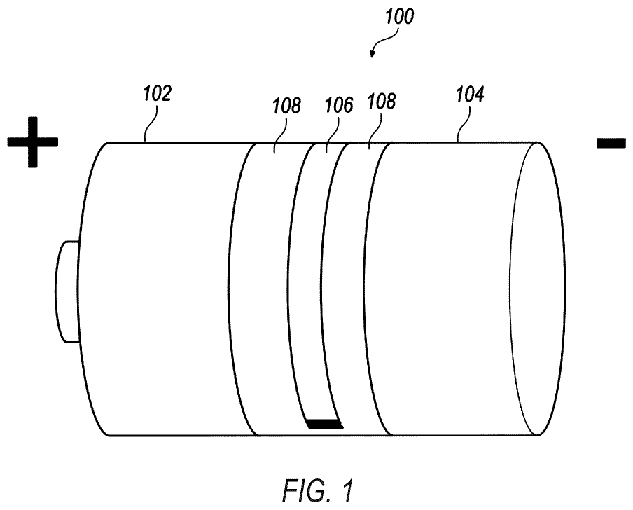

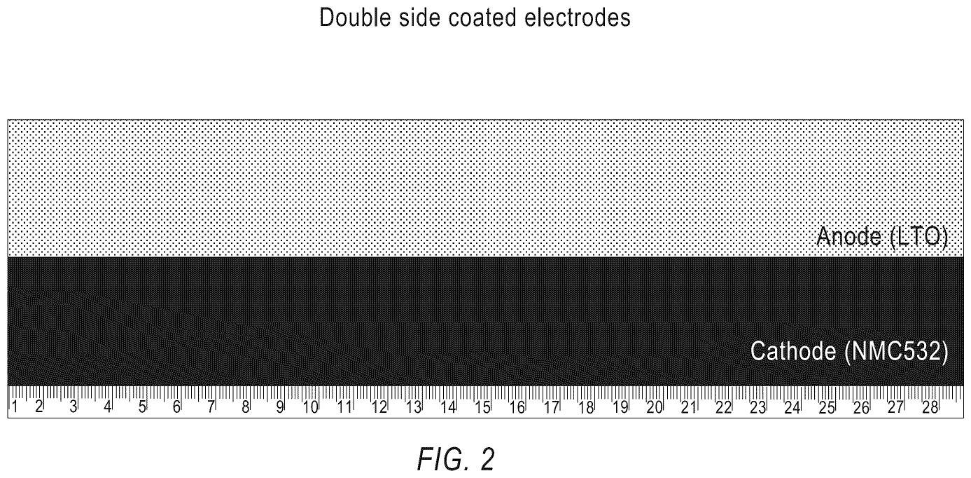

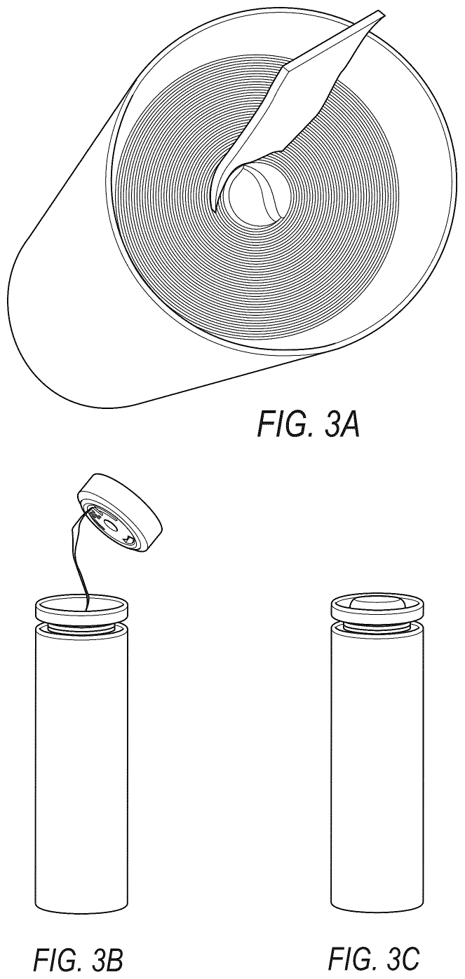

Referring now to the drawings, FIG. 1 shows a schematic illustration of a lithium-ion battery 100 according to the disclosure. The battery 100 may be implemented as an AA cell, but this technology can also be applied to different cell sizes such as 18650, 21700, 30700, 4680 and pouch cell formats. The battery includes a cathode 102, an anode 104, a separator 106 and an electrolyte 108 on either side of the separator.

The cathode 102 may be configured as a high temperature (i.e., thermally stable) cathode by utilizing LiNiₓMn_{y}Co,O₂, where x+y+z=1, including but not limited to NMC532 (LiNi_{0.5}Mn_{0.3}Co_{0.2}O₂), for example, which provides high energy density, structural stability, and thermal resilience. Nickel (50%) enhances capacity, Manganese (30%) improves thermal stability, and cobalt (20%) boosts electronic conductivity. Unlike higher-nickel variants, NMC532 maintains structural integrity at elevated temperatures, reducing phase degradation and transition metal dissolution. Pursuant to further implementations, the cathode comprises a material selected from a group consisting of LiNiₓMn_{y}Co_{z}O₂, where x+y+z=1, LiCoO₂, LiMn₂O₄, LiNiO₂, LiFePO₄, and combinations thereof. When paired with a phosphonium-based electrolyte, a stable cathode-electrolyte interphase (CEI) forms, minimizing capacity fade and enabling reliable cycling at 125° C. Electrochemical testing, discussed further below, confirmed minimal degradation, high-voltage stability, and long-term performance.

The anode 104 may be configured as a high temperature (i.e., thermally stable) anode by utilizing LTO (Li₄Ti₅O₁₂), for example, which provides stability, safety, and compatibility with high-temperature battery operation. The anodes may include pure LTO and carbon coated LTO, and Li metal anodes can be utilized for this chemistry. Unlike graphite anodes, LTO exhibits a zero-strain structure during lithium intercalation and deintercalation, which minimizes volume expansion and prevents mechanical degradation over extended cycling. This structural stability contributes to long cycle life, even at elevated temperatures. Additionally, LTO operates at a relatively high potential of approximately 1.55V versus Li/Li⁺, reducing the risk of lithium plating and dendrite formation, which enhances battery safety. Its thermal stability makes it well-suited for integration with the phosphonium-based electrolyte, allowing for stable charge-discharge cycling at 100° C. and beyond. These properties ensure that the LTO anode enables reliable, long-term performance in high-temperature lithium-ion battery applications. Pursuant to an implementation, the anode comprises a material selected from the group consisting of Li₄Ti₅O₁₂ (LTO), graphite, silicon, tin, lithium metal and combinations thereof.

A separator may be provided. The separator may be configured, for example, using a material selected from the group consisting of polyethylene, polypropylene, ceramic-coated separators, and combinations thereof. Pursuant to an implementation, the separator 106 is a polypropylene monolayer separator.

The electrolyte 108 may be configured as a nonflammable electrolyte composition (i.e., it does not ignite or sustain combustion when exposed to temperatures above 100° C.) by utilizing, for example, a thermally and electrochemically stable ionic liquid, a lithium conducting salt, and a film forming additive to enable operation at temperatures up to 100° C. and beyond. Traditional lithium-ion battery electrolytes use flammable organic solvents like ethylene carbonate (EC), diethyl carbonate (DEC), and dimethyl carbonate (DMC), which can ignite if the battery is punctured, short-circuited, or overheated, and fail above 60° C. By using a nonflammable electrolyte composition, the risk of thermal runaway, battery fires, and explosions is significantly reduced, making lithium-ion batteries safer for high-temperature and high-energy applications. Moreover, the nonflammable electrolyte composition can be adjusted in many ways by selecting different types of phosphonium ionic liquids, lithium salts, and solvent additives as well as co-solvents to fine-tune its properties (nonflammability, electrochemical and thermal stability, ionic conductivity, and viscosity). This optimized electrolyte composition is compatible with cell chemistry comprising high capacity NMC (LiNiₓMnᵥCo_{z}_{O}2, where x+y+z=1) cathodes and LTO anode, and offers higher energy density and capacity compared to LFP/LTO systems.

A thermally and electrochemically stable ionic liquid is one that remains in a liquid state at relatively low temperatures (often below 100° C.), possesses high thermal stability (i.e., it does not decompose or evaporate at elevated temperatures, typically up to 250-400° C.), and exhibits wide electrochemical stability (i.e., it can operate at high voltages, often exceeding 4.5V, without undergoing significant decomposition). The thermally and electrochemically stable ionic liquid may include a phosphonium-based ionic liquid, which provides thermal and electrochemical stability. The ionic liquid may include a combination of cations and anions. For example, a phosphonium ionic liquid cation can include multiple anion combinations including fluorosulfonimide, cyanoborate, and other phosphate-based and/or borate-based anions. Pursuant to an implementation, the phosphonium ionic liquid may be expanded to include derivatives and combinations of different family ionic liquids, including but not limited to nitrogen-based pyrrolidinium, nitrogen-based piperidinium, etc.

The lithium conducting salt can be selected from a group consisting of lithium bis(trifluoromethanesulfonimide) (LiTFSI), lithium perchlorate (LiClO₄), lithium bis(fluorosulfonyl)imide (LiFSI), lithium bis(oxalato)borate (LiBOB), 4,5-dicyano-2-(trifluoromethyl)imidazolide (LiTDI), and lithium tetrafluoroborate (LiBF₄). In some implementations, the lithium conducting salt has a concentration ranging from 0.2 M to 1 M or localized high concentrated conditions.

The film forming additive may include a borate-based additive. For example, the additive can be selected from a group consisting of lithium difluoro(oxalato)borate (LiDFOB), lithium difluoro(bisoxalato)phosphate (LiDFBP), fluoroethylene carbonate (FEC), and trimethyl silyl borate (TMSB). In some implementations, the film-forming additive has a concentration ranging from 0.1 wt % to 5 wt %.

In some implementations, the cathode and anode compositions, including LiNiₓMn_{y}Co_{z}O₂ where x+y+z=1 and Li₄Ti₅O₁₂ (LTO), respectively, can be utilized with LiTFSI based salt and LiDFOB additive to construct a practical AA cell. This cell was fabricated and evaluated for its high temperature capability, reaching up to 125° C., making it suitable for applications in the aviation and automotive industries, medical devices, and downhole drilling. Thus, lithium-ion battery 100 may operate beyond 100°° C., and up to at least 125° C., through the integration of a phosphonium-based ionic liquid electrolyte, a high temperature cathode (e.g., LiNi_{0.5}Mn_{0.3}Co_{0.2}O₂ (NMC532)), and a high temperature anode (e.g., Li₄Ti₅O₁₂ (LTO)). The phosphonium electrolyte forms a robust SEI layer on the high temperature anode and CEI layer on the high temperature cathode, ensuring minimal degradation. Electrochemical analysis confirmed that the phosphonium-based ionic liquid electrolyte enables stable operation at elevated temperatures and promotes the formation of a robust SEI layer on the high-temperature anode (LTO) and a CEI layer on the high-temperature cathode (NMC532), minimizing degradation and ensuring long-term stability.

Pursuant to an implementation, NMC532 cathode material was investigated with an ionic liquid-based electrolyte for high temperature interfacial stability study. In general, ionic liquids are considered to have high thermal and chemical stability and a wide electrochemical window. However, this is not always true that the stability of the ionic liquids is largely influenced by the complex molecular structures of the ionic liquid. Even though ionic liquids are thermally stable, electrochemical stability at high temperature is critical and it is dependent on various factors such as the interfacial interaction of the cathode, anode, and other components in the battery. In general, the thermal stability of the ionic liquid is mainly dependent on the less-stable ion in the composition (usually anion). On the other hand, the electrochemical stability of ionic liquids is dependent on both the cation and anion of the ionic liquid.

Fundamentally, the properties of ionic liquids can be tuned by choosing the appropriate cation and anion combination in the molecular structure of the ionic liquids. Ionic liquid cations may include pyrrolidinium (Nitrogen-based), piperidinium (Nitrogen-based), and phosphonium (Phosphorous-centered), and these cations possess chemical and electrochemical properties in combination with imide-based anions such as fluorosulfonimide (FSI) and trifluoromethane sulfonamide (TFSI) anions, With this motivation, ionic liquids have been studied for Li-ion battery applications, especially for room temperature and moderate temperature applications. A majority of research has mainly been focused on currently available cathode materials such as LiNiMnCoO₂ (NMC), LiFePO4 (LFP), LiNi_{0.5}Mn_{1.5}O₄ (LNMO), and anode materials like Si and Li₄Ti₅O₁₂. Unfortunately, the extensive knowledge of the interaction between ionic liquid and reactive cathode materials at extreme temperatures is certainly limited and this understanding is inevitable for the technological advancement in nonflammable Li-ion batteries using thermally stable ionic liquids. This disclosure now confirms that high temperature operation may be achieved through a unique electrolyte combination of phosphonium ionic liquid optionally with one or more Li conducting salt and one or more additives.

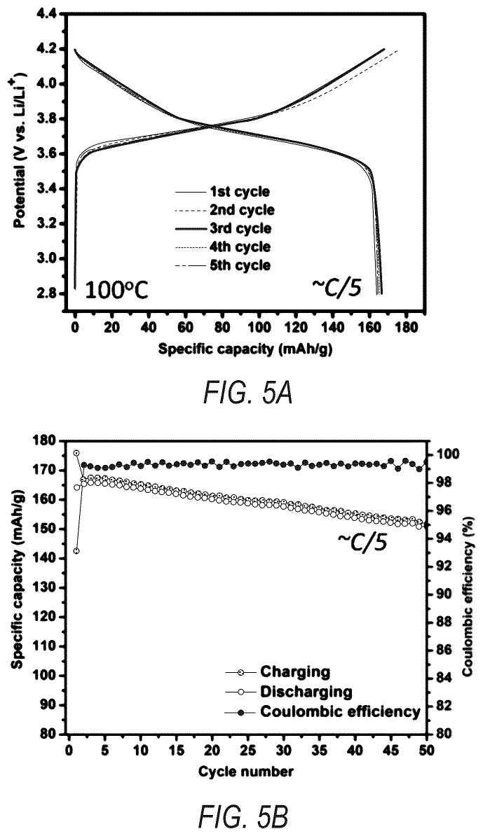

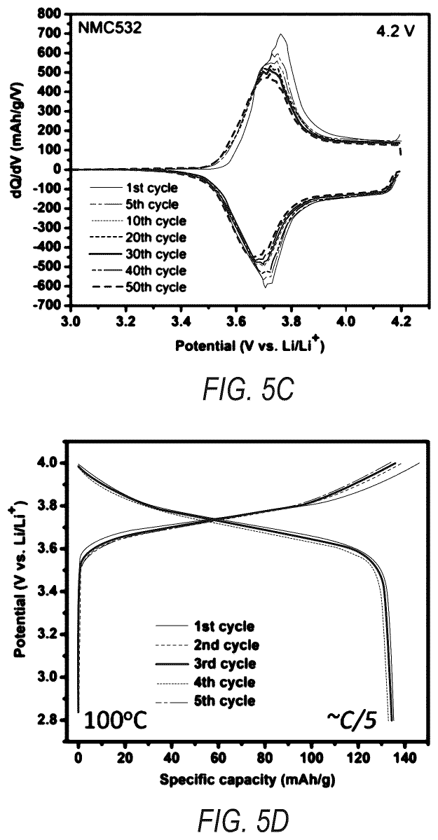

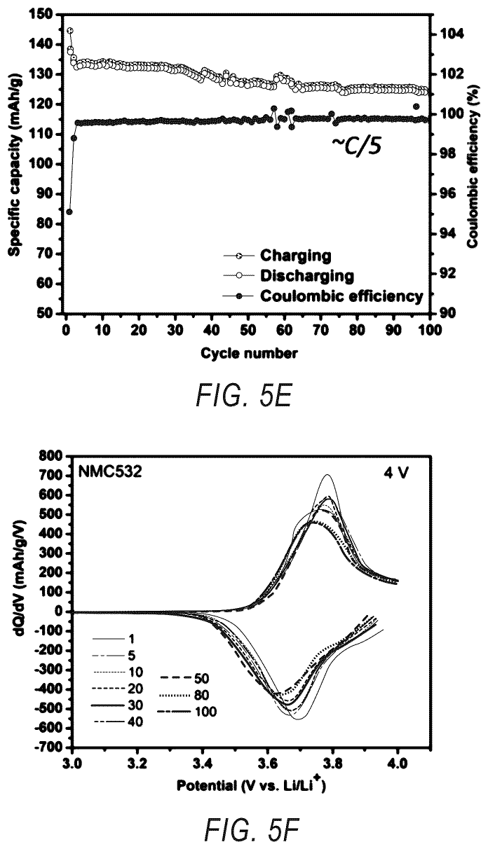

For the ionic liquids with common anion TFSI-, the electrochemical stability of ionic liquid follows the order imidazolium<pyrrolidinium<phosphonium. This was further proven with the initial test that the NMC532 with pyrrolidinium-based ionic liquid electrolyte was not stable at high temperature electrochemical reactions, leading to severe degradation at extreme conditions. With this observation, interfacial reaction study at high temperature operation of NMC532 cathode was studied with the best possible ionic liquid combination. Electrochemical properties of the NMC532 cathode in Ph₁₄₄₄ TFSI electrolyte with 0.5 mol/L LiTFSI and 0.5 w/v % LiDFOB film forming additive at 100° C. are shown in FIGS. 5A-5F.

Conventionally, Li extraction with respect to voltage can be used to calculate the extraction ratio of Li in the NMC532 cathode. According to the voltage window used in this study, the upper cut-off voltage of 4.2 V corresponds to 61% Li extraction and the cut-off of 4 V is responsible for ≈50% Li extraction. The Li extraction ratio affects the structural stability of the NMC family cathode materials, and the thermal stability of the cathodes mainly depends on the Ni content of the cathode materials.

Here, a moderate Ni content NMC532 cathode was used and the Li content extracted is within the stability window of the cathode to address the dominant contribution from the electrode-electrolyte interfacial reactions and their surface degradation phenomenon. FIG. 5A shows the voltage profiles of the NMC532 cathode cycled in the voltage range (2.8 to 4.2) V vs. Li, while FIG. 5D was cycled between 2.8 V and 4 V vs. Li at 100° C. In both cases, the voltage profiles of the NMC532 cathode cycled at 30 mA/g current density, but the first cycle was cycled at a slightly low current density of 20 mA/g. It is seen that the voltage profiles exhibit reversible lithiation and delithiation profiles at high temperature operation.

In ionic liquid electrolytes, during initial charge-discharge cycles, the used upper cut-off voltage has no significant effect on the voltage profiles and the initial capacity decay, indicating the complete reversibility of lithiation and delithiation reactions using ionic liquid electrolytes with CEI film forming additive in extreme environments. In addition, to evaluate continuous lithiation and delithiation effects with different voltage windows, the NMC532 cathode with 4 V upper cut-off voltage has also capacity decay during continuous cycling at high temperature operations. The continuous capacity decay at 4.2 V upper cut-off is mainly due to the interaction between reactive NMC532 cathode and ionic liquid electrolyte species. The ionic liquid electrolyte contains 0.5 wt % LIDFOB film-forming additive which forms a passivation layer on top of the cathode surface by an oxidative decomposition reaction. Due tothe solubility limitations of LiDFOB salt in phosphonium ionic liquid, the additive composition in the electrolyte is limited to 0.5 w/v %. Therefore, the film-forming additive can protect the cathode surface from parasitic reactions.

However, the protective mechanism can be influenced by various factors. For instance, the cycling test using an upper cut-off voltage of 4.2 V vs. Li/Li+ shows a consistent capacity fade, which may be attributed to nanoscale interactions of ionic liquid species at the electrode-electrolyte interfaces, as shown in FIG. 5B. In the case of the 4 V reaction, the cathode exhibits graduate capacity fade with a capacity retention of 90% after 100 continuous charge-discharge cycles at high temperature operations (FIG. 5E). Therefore, in both cases, there is a constant parasitic reaction between reactive cathode surface and electrolyte interfaces including the interface between Li metal and electrolyte interface. However, pursuant to an implementation, the NMC532 cathode and ionic liquid interaction at extreme temperature electrochemical operation is focused on exploring the high-temperature operation of NMC cathodes with nonflammable ionic liquid electrolyte combination for extreme temperature application. To further evaluate the redox couple evolution and capacity decay behavior of the NMC532 cathode upon cycling, the differential capacity vs. voltage profiles were derived from the charged discharge cycles for both 4.2 V and 4 V upper voltage conditions.

In general, information regarding the redox couple evolution, phase evolution, and polarization effects on capacity decay can be visualized by dQ/dV profiles. In the first cycle, the NMC532 cathode exhibits an oxidation peak at 3.8 V upon charging and 3.7 V upon discharging for different voltage conditions (4 V and 4.2 V). As the cycling continued, the redox peaks exhibit no change in shape but shift to a slightly low voltage region in both 4.2 V and 4 V cycling conditions. The gradual shift in the dQ/dV plot is mainly due to the polarization effect that may have originated from the interfacial degradation as a result of parasitic reactions at high temperature lithiation delithiation reactions. The decrease in intensity of the dQ/d V peaks confirms the gradual capacity fade upon cycling. This capacity fade is mainly due to the degradation reaction originating from electrochemical interaction of the ionic liquid species and salt anion species with reactive cathode surface as the high upper cut-off voltage exhibits a slightly high-capacity fade due to the increased parasitic interaction at high voltage.

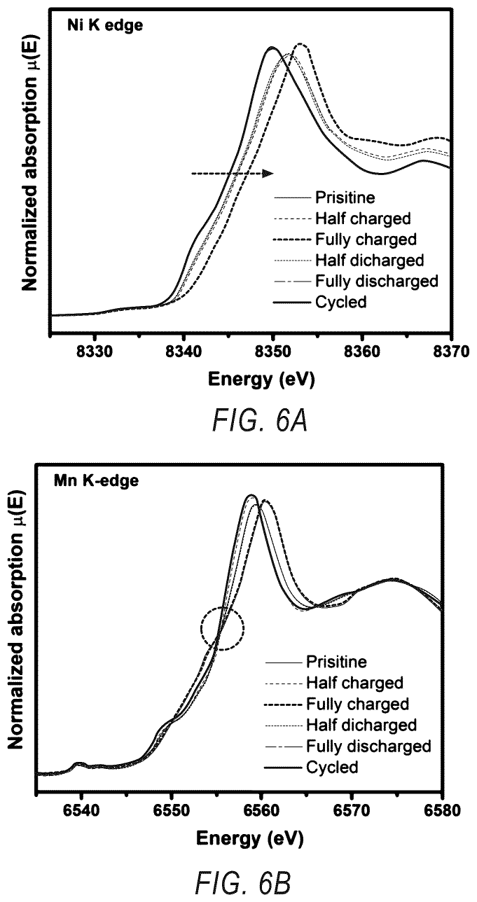

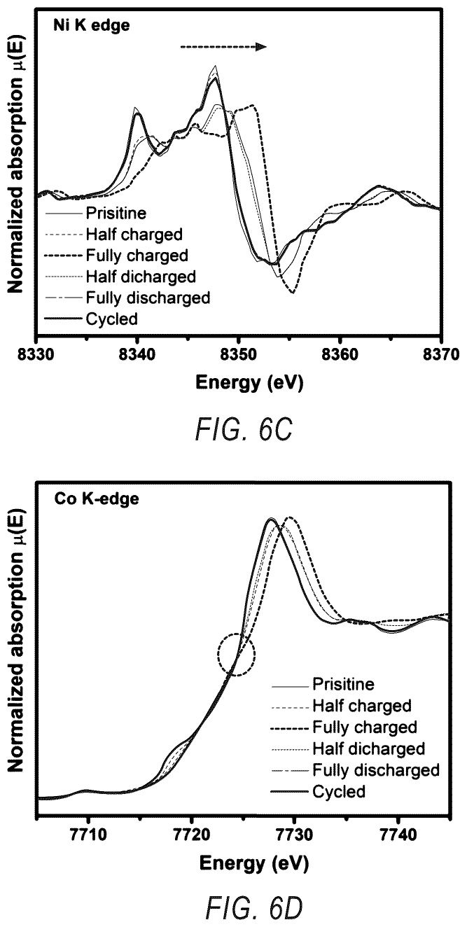

After understanding the electrochemical reversibility at high temperature lithiation/delithiation reaction, the NMC532 cathode cycled in ionic liquid at different states of charge was characterized by hard X-ray absorption near edge spectroscopy (XANES) measurements of the transition metal K-edge to evaluate the charge compensation reaction at high temperature electrochemical reaction. The normalized spectra for the Ni, Mn, and Co K-edges at different states of charge conditions including pristine, charged to 3.8 V, fully charged, half discharged, and cycled samples as shown in FIGS. 6A-6D. Fundamentally, the XANES spectrum consists of two important components: (i) main absorption edge or white line that is attributed to the transfer of 1 s core electrons to 4 p states; (ii) the pre-edge peaks before the main absorption edge. The pre-edge peak originated from the dipole forbidden transition of 1 s electron to 3 d transition but partially allowed through quadruple coupling through 3 d-4 p orbital mixing from the noncentrosymmetric environment of the slightly distorted octahedra. The main absorption edge is ascribed to the dipole-allowed 1s-4 p transition.

Conventionally, the rigid shifts in the absorption edge energy are attributed to the changes in the average oxidation state of the atom being probed. At a high oxidation state, the electron-electron repulsion will be less than the low valent state. Therefore, the core electrons have a strong tendency to bind with the nucleus requiring high ionization energy to eject core electrons through photoionization. Hence, the main absorption edge energy shifts to high energy when the probing atom is oxidized to high oxidation states. In general, the pristine NMC532 cathode consists of Mn⁴⁺ and Co³⁺ cations but the average oxidation state of Ni atom is more than two. FIG. 6A shows the Ni K-edge spectra of the different states of charge samples cycled at high temperature of 100° C. in the ionic liquid electrolyte.

Compared to Ni K edge spectra of standard NiO, the pristine composition exhibits high edge energy, indicating the average oxidation state of the Ni atom in the pristine state is more than two. At a fully charged state, the edge further shifts to high energy around 8340 e V, implying that the Ni atoms are oxidized to a high oxidation state. In NMC family cathodes, the Ni^{2+/4+} is the dominant redox couple in the potential region of 3-4.3V vs. Li. This potential window is ˜60-80% extraction ratio in NMC family cathodes based on their Ni content (NMC111, NMC532, NMC622, and NMC811) with different Ni and Co content in the sample. However, overcharging beyond 4.5 V vs. Li leads to irreversible degradation and oxygen release and also partial charge compensation reaction from Co atoms in the high Ni content cathodes. Further, half-charged and discharged conditions show a rigid shift to high energy between pristine and fully charged state of 4.2 V vs Li. The edge energies of the fully discharged and cycled cathode recovered back to a pristine state, indicating the reversible lithiation/delithiation reaction of the NMC532 cathode at 100° C. in phosphonium ionic liquid electrolyte.

After understanding the bulk Ni redox reaction, the Co and Mn redox contributions were evaluated. Conventionally, the Mn⁴⁺ and Co³⁺ cations are buffer cations, and they do not take part in the redox reaction in moderate voltage conditions. Compared to Ni K edge spectra, the Co and Mn K edge interpretation is not straightforward. FIG. 6C shows the Co K edge spectra of different states of charge samples. Unlike Ni K edge spectra, the Co and Mn K edge spectra exhibit no rigid shifts to high energy upon Li-ion extraction. However, the observed changes in the line shapes can be attributed to the changes in the local coordination environment, symmetry, and metal-ligand covalency features. In addition, the pre-edge features also provide information about the local environment of the absorbing atom. After close inspection of the pre-edge peaks, it is confirmed that the pre-edge intensity was slightly increased as the voltage reached 4.2 V.

To date, the significant increment in the pre-edge intensity of Co XANES spectra was used to correlate the symmetry distortion phenomenon around the Co atom, and the behavior was mainly explained by Co migration phenomenon from the octahedral environment to the tetrahedral environment. In general, the pre-edge features of the Ni, Co and Mn elements originated from the electric quadrupole transitions rather than electronic dipole transitions. The quadrupole transition is less intense than the dipole transition and can occur in an octahedral environment. Therefore, the weak pre-edge features observed in the Ni, Co, and Mn XANES spectra confirm that the elements are not migrated to the tetrahedral environment in the bulk of the material after being tested in the cathode at high temperature operation of 100° C. in phosphonium ionic liquid electrolyte.

Although the bulk properties of the NMC532 cathode at high temperature operation were studied through XANES analysis, electronic structure variation on the particle surface and sub-surface regions cannot be identified with bulk-sensitive measurements. The surface regions of the Ni-based cathode materials are highly reactive with electrolyte species and the chemical interaction between electrode and electrolyte is reactive at high states of charge and extreme temperature conditions. To date, in-depth surface and bulk charge heterogeneities of state-of-the-art cathodes at extreme temperature operations using ionic liquid electrolytes are certainly limited. Understanding the charge heterogeneities for the high temperature electrode materials is of paramount importance to understanding and designing stable electrode electrolyte interfaces for high temperature batteries. Soft X-ray absorption spectroscopy (sXAS) is used to probe surface regions of the particles with X-rays of energy in the range (150 to 2000) eV. FIG. 4 illustrates depth-dependent probing modes in a cathode particle, highlighting different X-ray absorption techniques used to analyze various layers of the material. Unlike transition metal K edge XAS, the sXAS can be used to non-destructively study the depth-dependent properties of reactive cathode surfaces. sXAS probes the L-edge of transition metal where electric dipole allowed transition of 2 p to 3 d state is achieved through excitation of 2 p electron due to spin-orbit coupling, the metal L-edges of transition metal observed (L3 and L2 edges) in the ratio of 2:1. The metal L3 and L2 edges are highly sensitive towards oxidation state, crystal field strength, electronic spin state polarization and multiplet effects.

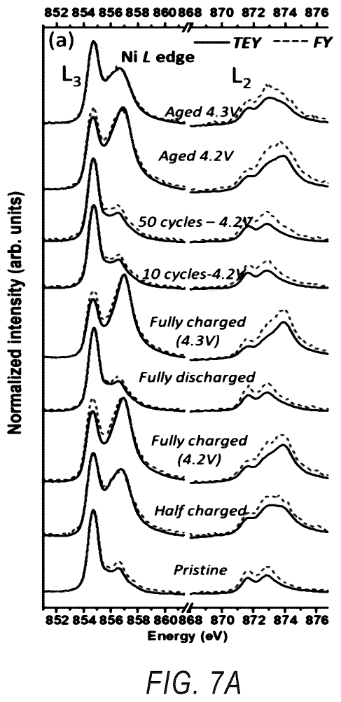

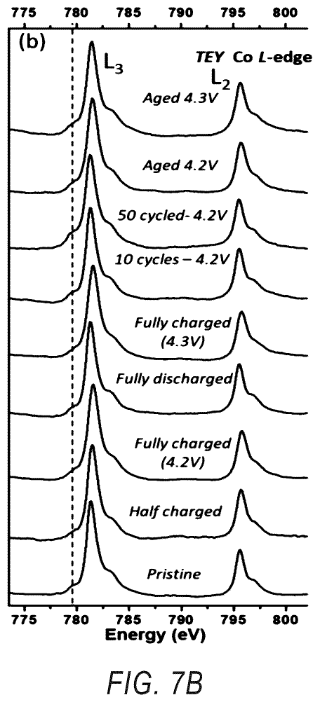

The Ni L₃ and L₂ edges of the NMC532 cathode cycled at different states of charge conditions are shown in FIGS. 7A-7B. In the L₃ edge, the observed two peaks are known as L₃ (high) and L₃ (low). The intensity ratio between the L₃ (high) and L₃ (low) will be used to semi-quantitatively understand the Ni redox properties at different states of charge conditions. Fundamentally, the Ni-based NMC cathodes exhibit depth-dependent charge heterogeneities in the surface and bulk of the cathode particles that is largely affected by various conditions such as aging, cycling at the extreme environment, charge rate, and voltage window. With this understating, the high temperature operation of NMC532 cathode in ionic liquid was studied using depth-dependent modes of soft X-rays for different cycling conditions including different voltage windows, aging, and cycling conditions at high temperature operation. In general. soft X-ray absorption experiments probe surface to bulk regions, with depth-dependent probing based on the mode of detection used. Pursuant to an implementation, the sXAS experiments (also referred to as Near Edge X-ray Absorption Fine Structure-NEXAFS) used three modes of detection simultaneously: partial electron yield (PEY, 1 nm to 2 nm deep from surface), total electron yield (TEY, 5 nm to 10 nm), and fluorescence yield (FY,≈50 nm). Therefore, soft XAS can be used to probe the sensitive surface with different depth levels.

As shown in FIG. 7A, a typical L-edge spectrum of Ni L-edge with TEY mode is shown in a solid blue line, and FY is plotted in dotted lines. In NMC 532, Co and Mn are in Co³⁺ and Mn⁴⁺ oxidation states, respectively. On the other hand, Ni atoms are present in mixed valence states with mainly Ni²⁺ (≈60%) and Ni³⁺ (40%). Moreover, the Ni L-edge consists of L₃ and L₂ edges due to spin-orbit coupling. Comparing bulk FY and surface-sensitive TEY spectra, the intensity ratio of FY is slightly higher than the TEY mode, indicating that the Ni oxidation state is higher than the surface region. This observation is in agreement with previous soft X-ray measurements for layered NMC cathodes, wherein the surface region is more reduced state than the bulk region. In addition, at a fully charged state (4.2 V), significant changes in both TEY and FY Ni L-edge spectra compared to pristine NMC532 cathode. Interestingly, the fully charged sample shows significant variation in intensity ratio for FY and TEY spectra as the FY spectra exhibit less oxidation than the TEY spectra. However, the FY and TEY spectra of half charged sample exhibit no variation in intensity ratio which confirms that the surface and bulk charge heterogeneities are minimal at a low state of charge condition at high temperature operation.

Conversely, surface and bulk charge heterogeneities are observed in the fully charged condition that may be associated with the high voltage local interaction between phosphonium ionic liquid species and NMC532 cathode surface regions. The possibility of parasitic reaction between NMC cathode surface and ionic liquid species are different at different depth levels as the surface Ni redox state is slightly reduced compared to bulk. This behavior of surface reduction is mainly attributed to the electron transfer between anionic liquid electrolyte anionic species (TFSI⁻) and reactive high valent Ni⁴⁺ redox states through anionic decompositions. This might suggest that this reduction process is only accelerated at a high state of charge conditions and not during the additive decomposition process at initial cycles. The reason is that additive decomposition is dominated during initial cycles and the additives are sensitive to their oxidation potential and form a passivation layer on top of the cathode through electrochemical decomposition. However, the surface transition metal reduction is dominated by surface reaction between a high state of charge cations and anionic species at high temperature aging process, implying that the high valent cation can accept electrons from electrolyte species, that is, anionic oxidation to release electrons slowly to the surface of the cathode for transition metal reduction. This is why the transition metal reduction is only limited to the surface rather than the bulk of the cathode particle. When discharged to 2.8 V, the FY and TEY of Ni L₃ doublet are completely reversed, confirming that the Ni redox reaction is highly reversible even at 100° C. with an ionic liquid environment,

Fundamentally, the intensity ratio increases as Ni oxidation state is increased. In addition, after charging to 4.3 V charge cut off, the L₃ peak of TEY and FY spectra show an apparent increase compared to 4.2 V charged state. After initial charge-discharge conditions, the cycling conditions of the NMC532 cathode were evaluated. The intensity ratio of L₃edge after 10 and 50 cycles are almost similar but FY Ni L₃-edge spectra of cycled cathode after 50 cycles show slightly higher oxidation than the TEY mode. This observation is mainly due to the interfacial reaction between the electrode surface and ionic liquid as the electron transfer from the oxidative decomposition of ionic liquid species, especially anionic species, on top of the charged oxide cathode surface of the NMC532 cathode during repetitive cycling at high temperature. Moreover, extreme temperature aging was studied at two different voltage conditions 4.2 V and 4.3 V, and the charged cells were kept at 100° C. for 7 days to understand the interfacial reactivity of the charged cathode as a function of voltage window. Interestingly, the L₃-edge of 4.2 V aged cathode exhibits changes in the TEY spectrum compared to FY, indicating that the surface region of charged NMC surface involves parasitic reactions such as surface reconstruction and surface oxygen loss.

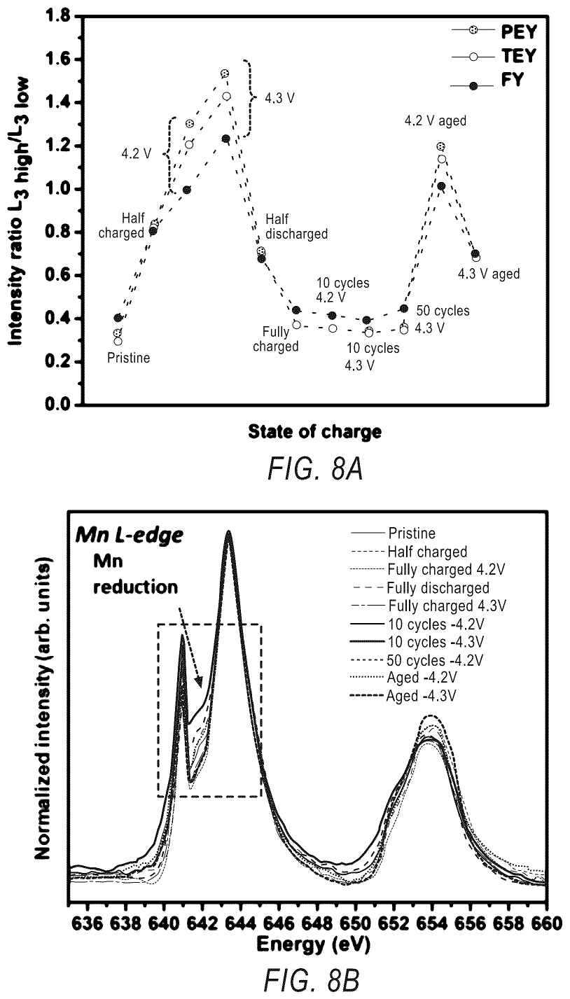

Compared to 4.2 V, the intensity ratio of 4.3 V aged cathode both in the FY and TEY spectra decreased significantly, and the ratio reached almost similar to half charged state. The reduced Ni valence state after 4.3 V aging is mainly from the accelerated parasitic reaction between the cathode surface and ionic liquid electrolyte at high temperature aging. At high temperature aging, the charged cathode with Ni⁴⁺ species can consume electrons from the ionic liquid anionic oxidative decomposition, resulting in the depth-dependent interfacial reaction at high temperature operation. In addition, high temperature operation can also contribute to surface oxygen loss at high voltage charge conditions. To date, thermally treated cathode materials at high temperature after being discharged at high temperature exhibit a mixture of spinel and rocksalt phase formation at the surface region due to oxygen loss and transition metal reduction followed by surface reconstruction to rock salt phase formation. This surface reconstruction mechanism was evaluated through X-ray spectroscopy and different microscopy investigations. In previous investigations, the NMC333 layered cathode interfacial stability was studied by the combination of X-ray spectroscopy and microscopy investigations and layered to spinel transformation due to surface degradation was identified through microscopy evaluations. Similarly, the surface reduction phenomenon was observed due to the parasitic reaction phenomenon between the reactive cathode surface and ionic liquid electrolyte species, leading to possible surface reduction and oxidation gradient of transition metals in materials. FIG. 7A shows Ni L₃ peak intensity ratio was plotted against different cycling conditions. The depth-dependent Ni oxidation state variation was analyzed through Ni L₃ edge intensity variation. As shown in FIG. 7A, the depth-dependent variation is high for the fully charged state, cycled states and 4.2 aged cathodes. The huge variation in the fully charged state is mainly due to the charge heterogencity nature of NMC cathode at moderate Li extraction and the possibility for highly oxidized surface region to use up electrons from the oxidative decomposition of electrolyte species. This is the reason the high voltage aging consumes electrons from parasitic reactions and exhibit minimal charge heterogeneity in the different depths. Simplified intensity ratio plots derived from FIG. 7A are shown in FIG. 8A.

Compared to Ni L edge spectra, Co and Mn L edge in NMC532 exhibit no significant spectral variations at different states of charge conditions. Ideally, in moderate Ni content cathodes, Co and Mn are present in 3+ and 4+ oxidation states, resulting in the majority of the electrochemical charge compensation reaction being compensated by Ni redox couple. Pristine Co L-edge TEY spectrum show two main peaks at 777.5 eV and 791.8 eV designated as L₃ and L₂, respectively, due to the spin-orbit coupling (FIG. 7B). Unlike Ni L-edge spectra, Co L edge spectra maintain almost the original spectral features for all the sample conditions including half and fully charged, 4.3 V charged, cycled cathode both 10 and 50 cycles, and aged cathodes at 4.2 and 4.3 V. The TEY probing is considered surface sensitive for this study, and the probing depth is approximately 10 nm from the surface.

Based on the spectral features, it is clearly seen that the Co³⁺ has no charge contribution towards electrochemical reaction during high temperature operation in ionic liquid electrolyte. However, by analyzing closely, it is seen that a shoulder peak is observed for the sample cycled for 50-cycles at 100° C. In general, the low energy features are observed in similar NMC family cathodes at even room temperature but with mainly extended cycling and high voltage operation of more than 4.6 V. The observed feature is mainly attributed to the surface Co³⁺ reduction to lower valence Co ions, and the surface reduction is mainly driven by high voltage-induced surface oxygen loss. In the ionic liquid study, the low voltage 4.2 V exhibits a similar low energy feature, indicating the high temperature parasitic reaction reduced the surface Co species slightly to surface regions in the probing depth of 10 nm from the surface. Similar to the Co L edge, the Mn Ledge spectra also maintain pristine Mn Ledge features at different electrochemical cycling conditions.

However, the intensity of the shoulder peak around 642 eV increased slightly for the cycled cathode at 4.3V (FIG. 8B). The behavior can also be related to possible surface reduction of high valent Mn reduction. In addition, with the exception of the pristine, half and fully charged to 4.2V, fully discharged cathodes, the samples show the shoulder features around 642 eV. Their features indicated that the partial Mn reduction occurred in the region of 10 nm from the surface for high voltage cycling conditions. Based on the depth-dependent sXAS measurements, the observed transition metal reduction phenomena can be directly correlated to the electrochemical performance of the NMC532 cathode at high temperature operation. The gradual capacity decay observed in the 4.2 V cut-off is higher than the low voltage cut-off of 4 V vs Li. Repetitive cycling is accelerating the sensitive surface reconstruction reaction even at the voltage of 4.2 V vs. Li, which is relatively low voltage compared to other voltage conditions used in carbonate electrolytes even at room temperature. The observed cation reduction was further enhanced during forced aging at high-temperature operation. This aging reaction resulted in surface degradation relative to voltage conditions, suggesting that the interaction between the ionic liquid and the reactive cathode surface may involve a similar mechanism of surface degradation, such as surface reconstruction and early oxygen loss, at high temperatures compared to conventional liquid electrolytes at room temperature.

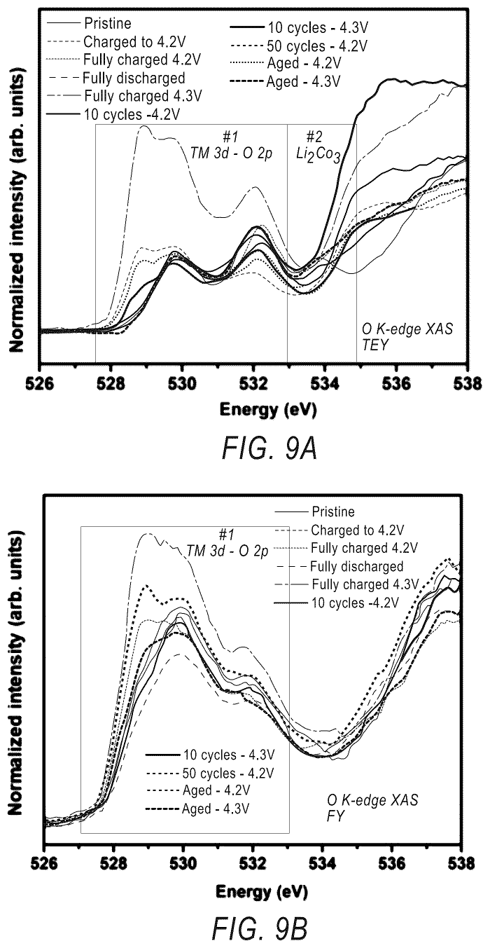

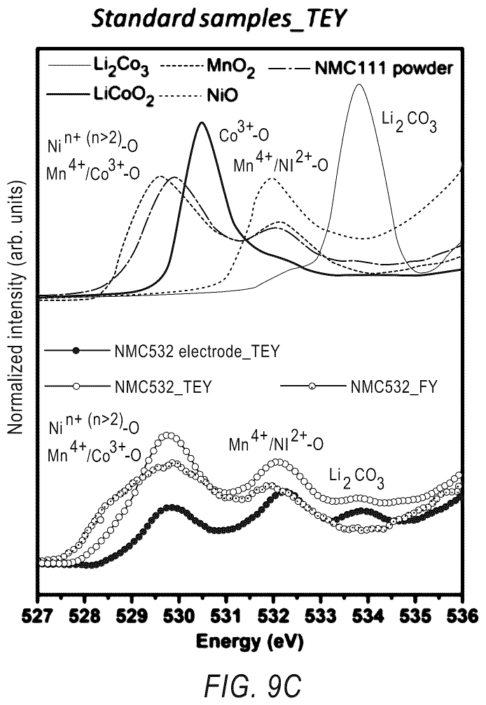

To further explore the metal-ligand interaction, the oxygen ligand K edge absorption study was carried out with soft X-ray absorption spectroscopy measurements. The pre-edge peak position and intensity variations have a strong correlation to structural information and bonding interactions between metal and ligand. Fundamentally, O K edge spectrum can be divided into two regions: a low energy pre-edge region below 532 eV corresponding to the transition of O 1 s electron to the hybridized transition metal TM 3 d-O 2 p orbitals and a high energy spectral feature above 534 eV which is related to the O Is electron transition to the hybridized TM 4 sp- O 2 p hybridized states. Similar to transition metals, the O K-edge analysis was also performed in depth-dependent detection modes to understand the electronic structure information of high temperature lithiation-delithiation reaction of NMC532 cathode in thermally stable ionic liquid electrolytes. To effectively interpret O Kedge spectra, the TEY of the standard transition metal compositions with different oxidation states and the electrochemically cycled cathode materials were measured (FIG. 9C). The surface-sensitive and bulk-sensitive spectra of NMC532 cathode with varied cycling conditions are shown in FIG. 9A and FIG. 9B, respectively. The pristine cathode before any contact with the electrolyte species shows strong spectral features at 530 eV, 532 eV and 533 eV and a broad peak beyond 534 eV. The spectral features below 532 eV are strongly influenced by the transition metal and oxygen ligand covalency which is varied largely by the electrochemical lithiation/delithiation at different potential conditions. Based on reference sample peaks, a peak at 532 eV is present only in the pristine composition, indicating that the Li₂CO₃ surface-adsorbed carbonate species that are commonly observed in Ni-based intercalation cathode materials.

As shown in FIG. 9B, the Li₂CO₃ feature is not observed in bulk-sensitive FY spectra of pristine and other sample conditions. Also, FY measurement of NMC532 powder has no Li₂CO₃ features, indicating that Li₂CO₃ species are not forming after electrode preparation and it clear that Li₂CO₃ is completely from surface adsorption species. Confirming that the Li₂CO₃ species are only limited to surface regions and not present in the bulk region 100 nm from the particle surface. Importantly, the Li₂CO₃ signal vanishes for the cathodes that have electrochemically charged to different voltages such as 4.2 V and 4.3 V and the signal is not pronounced even in discharged condition. This behavior confirms that the electrochemical oxidation process decomposes the Li₂CO₃ during initial cycles and the regeneration of Li₂CO₃ does not occur after electrochemical discharge reactions. Therefore, the Li₂CO₃ originates purely from the cathode synthesis process and storage conditions. Another important observation is that the pre-edge peak intensities and area under the curve increase during electrochemical delithiation,

Based on studies of NMC family cathodes, the pre-edge peak intensity variation is strongly correlated to changes in TM-O covalent interaction resulting from the transition metal oxidation upon delithiation. In NMC532, the charge compensation is believed to be purely from the cationic redox but the high voltage delithiation can trigger irreversible anionic contribution in high Ni-content cathodes as similar phenomenon was observed reversibly in Li-rich oxides. In NMC 532, the Ni is in mixed oxidation state while the Co and Mn are present in 3+ and 4+ oxidation states, respectively. The electrochemical charge compensation is mainly achieved through Ni redox couple during electrochemical Li extraction up to 70%. Pursuant to an implementation, when charged to 4.2 V, the peak intensity of low energy features in the TEY spectrum significantly evolved and increased further as voltage increases. The low energy feature around 529 eV is attributed to the Ni³⁺—O hybridization, as was previously observed in LiNiO₂ cathode material where Ni is in 3+ oxidation state. Further, the strong peak at 530 eV is corresponding to Mn⁴⁺—O contribution along with the contribution of Ni³⁺—O and Co³⁺—O (FIGS. 9A-9C). The peak before Li₂CO₃ is attributed to the Ni²⁺—O feature also contribution form Mn⁴⁺—O. The fundamental difference in spectral features between TEY and FY is mainly due to the depth dependent electronic structure of the NMC532 cathode particles. Also, the TEY probing depth is approximately 10 nm from the surface and this surface sensitive signal can be affected by oxygenated species from the CEI derived from oxidative decomposition of ionic liquid species especially anion TFSI⁻ and additional anion species from additive salt (LiDFOB). When charged to 4.3 V, the bulk-sensitive FY signal peak intensity increased due to the significant variation in the metal-ligand covalency. This feature is often correlated with the Ni redox reaction as the Ni oxidation upon delithiation at a high state of charge improves the covalency between Ni 3 d and O 2 p orbital states. Besides, the peak intensity reversed back to low both in FY and TEY spectra when the cathode is discharged to 2.8 V vs Li. The possibilities are that the changes in the metal ligand covalency increased upon delithiation and a possible surface oxygen loss due to high temperature electrochemical reactions.

Compared to FY spectra, the surface sensitive TEY spectra showed sharp Ni²⁺—O contribution around 532 eV, indicating that the surface region was more reduced than the bulk region. This observation agrees with the Ni intensity ratio of pristine sample, where the PEY and TEY data confirmed that the Ni ratio is lower than FY, indicating the more reduced form in the surface compared to the bulk region of 100 nm depth from the surface. Another important observation is that FY spectra of 4.2 V fully charged cathode show a less intense pre-edge intensity peak around 532 eV than all other samples, confirming that the surface reduction is accelerated at high voltage cycling or extended cycling conditions. Cycled samples 4.2 V, 4.3 V, and 50 cycles at 4.2 V show similar behavior in which the cycled cathode with 4.3 V cut-off exhibits a more intense peak at 532 eV than other sample conditions. The surface reduction argument is proven with aged sample conditions in which the 4.3 V aged cathode almost like 4.2 aged cathode but displays less intensity than all other sample conditions due to the surface reduction of Ni species resulting from the high temperature parasitic reactions. This surface reduction argument of Ni species from O K-edge measurement is consistent with the Ni Ledge intensity ratio where the intensity ratio of 4.3 V aged cathode reduced to almost the position of half charged state. (FIG. 8A/Intensity ratio). However, the FY spectra of O K edge spectra show significant variation in low energy region (528 to 530) eV.

Due to bulk probing depth, the FY spectral features are less affected by the parasitic reactions, surface oxygen loss, charge heterogeneity, and surface reduction. One important thing to note is that the low energy features are reversible for charged and discharge states, but the aged 4.3 V cathode lost its low energy features due to the surface reduction phenomenon of transition metals at high temperature electrochemical reactions. Unlike FY spectra in the high energy region, the TEY and PEY spectra exhibit broad spectral features without any trends, and this observation is mainly attributed to the oxidative decomposition of ionic liquid anionic species and additive anionic species to form oxygenated CEI layer and decomposed products on top of the NMC532 cathode surface within the 10 nm region. With the advantage of depth-dependent probing, the surface and bulk charge heterogeneities of cathode materials cycled at high temperature ionic liquid electrolytes were confirmed using soft X-ray absorption spectroscopy investigation. Though the charge heterogeneities are identified, the depth-dependent CEI properties and the surface chemistry of the cathode material cycled at different cycling conditions cannot be identified through the sXAS measurements. Therefore, energy-tunable X-ray photoelectron spectroscopy measurement was introduced to investigate species identification of the CEI layer and the decomposed species formed on top of the NMC532 cathode material.

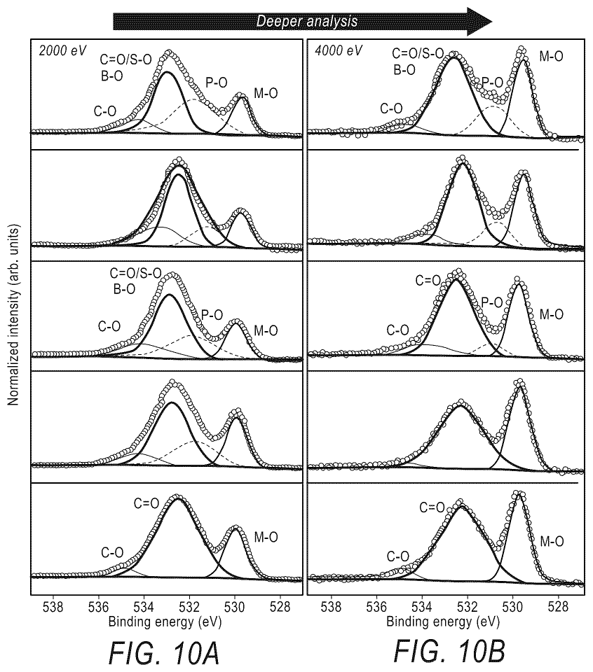

To understand the depth-dependent chemical composition of the CEI formed on the surface of the NMC cathode at high temperature operation, measurements were made using tunable energy synchrotron-based XPS technique. The photoemission measurements were carried out at surface sensitive, near-surface, and bulk-sensitive photon energies of 800 eV, 2000 eV and 4000 eV, respectively. FIGS. 10A-10B show the near-surface and bulk-sensitive O 1 s HAXPES spectra of the NMC532 cathode cycled at high temperature conditions. Compared to 2000 eV (FIG. 10A), the photoemission features at 4000 eV (FIG. 10B) represent information about the buried surface of the CEI layer due to deeper probing depth without mechanically milling the sensitive CEI surface. First, the observed low energy peak at about 530 eV originated from the lattice oxygen contribution of the metal-oxygen (M-O) feature in the NMC532 oxide cathode FIG. 10B. It is clearly seen that the intensity of lattice oxygen contribution is significantly higher compared to the near-surface region (2000 eV) (FIG. 10A). This indicates that the surface passivation through the electrolyte and additive species decomposition is masking the M-O features. At pristine state, the O 1 s species for both near-surface (2000 eV) and bulk-sensitive (4000 eV) spectra exhibit the O 1 s features at about 530 eV, 533 eV, and 534 eV, which are attributed to the transition metal oxide cathode, chemically formed C═O from Li₂CO₃, and different forms of oxygenated carbon species C—O from electrolyte decomposition products. Mainly, the M-O signal is highly sensitive to photon energy as the high photon energy probed the M-O contribution penetrated through the Li₂CO₃ surface layer in the pristine cathode. Unlike pristine conditions, the electrochemically cycled sample conditions exhibit an additional peak at about 532 eV, which is responsible for the phosphorous and oxygen (P—O) species existing in the CEI derived from phosphonium ionic liquid parasitic reaction with the cathode surface. A similar feature was also observed in deeper surfaces of the cycled conditions except for Ist discharged condition. Next, a high intense peak at about 533 eV was observed in all the sample conditions and also at different depth levels, indicating that the dominant feature originated mainly from the electrolyte cathode surface parasitic reaction products such as Li2CO3, B—O/S—O species from the anion-derived species. Also, a feature at about 534 eV is assigned to a different form of carbon species, that is, C—O environment.

After the first discharge, the near-surface regions exhibit an additional P—O signal compared to the pristine state. The relative intensity of the two dominant peaks (C═O and M-O) exhibit negligible changes, indicating that the initial electrochemical reaction is not thick enough to fully passivate the M-O features with respect to the photon energy of 2000 eV (FIG. 10A). Further, the bulk sensitive photon energy of 4000 eV reveals similar features like a pristine state, a highly intense M-O feature was observed compared to 2000 eV, confirming that the initial cycle is not enough to form stable and thick CEI on the NMC surface. This is in contrast to the conventional additive formation mechanism wherein the additive molecules decompose and passivate the electrode surface during initial cycles and thereby become stable CEI species. Here, the observed phenomenon is mainly due to the amount of additives for decomposition is limited because the 0.5 mol/L LiTFSI in phosphonium ionic liquid contains only 0.5 wt % LiDFOB additive. The low quantity of additive was used due to the solubility limitations of LiDFOB salt in viscous ionic liquid electrolyte. In previous investigations, a 2 wt % LIDFOB additive was used to passivate NMC333 surface, and it was proven that the F-rich additive derived species completely passivated the NMC surface during initial high temperature operation. Considering this behavior, the observation in current findings is strengthening the point that the decomposition species are not only from LiDFOB, and additional species also contribute to surface layer composition upon repetitive cycling. Apart from pristine and first discharge conditions, the sample conditions (cycled, aged at 4.2 V and aged at 4.3 V) confirm the CEI formation on the NMC cathode surface as the relative intensity of the two main peaks increased as shown in the surface and bulk sensitive analysis.

This phenomenon is primarily due to the decomposition products from the ionic liquid parasitic reaction, additive anion decomposition (DFOB-), and salt anion (TFSI-) derived species (see First three rows in FIG. 10A and FIG. 10B). Unlike the bulk of the CEI layer, the O 1 s spectra of near-surface region (2000 cV) contain two significant peaks, such as M-O signal at 530 eV and surface oxygenated surface layer species at 532 eV. In all cases, the surface oxygen signal dominated as compared to M-O signal, indicating that the electrochemical reaction significantly modified the surface and passivated the cathode surface through CEI formation. After 50 cycles of continuous charge-discharge cycles, the surface region exhibits M-O, P—O, C═O, and C—O species but the relative intensity of the C—O, and P—O species in the bulk region is slightly less and M-O signal is pronounced (FIG. 10B, 3rd row). This behavior clearly confirms that the CEI layer is not too thick. As shown in sXAS studies, the high temperature aging phenomenon modified the electronic structure of the NMC cathode surface at different depth levels. To further evaluate the aging effect on CEI composition, similar to sXAS samples, two sample conditions were aged after being charged to 4.2 V and 4.3 V upper cut-off voltages. In the surface region, there is so significant difference in the M-O signal for both 4.2 and 4.3 V conditions, confirming that CEI thickness is not increasing further to passivate the M-O features after being aged at 4.3 V for 7 days. However, the peak shape of the 4.3 V aged cathode slightly changed which may be due to the interaction of ionic liquid and salt anion species interacting with reactive NMC surface at high temperature aging. More importantly, the relative intensity between the C═O peak and P—O at 4.3 V aging cathode is high, confirming that the compositional variation from the passivation is mainly through phosphonium ionic liquid species and additive DFOB and TFSI derived species. Also, the buried surface of the CEI layer reflects the same behavior but the M-O intensity is high compared to carbon species, indicating that the aging at high temperature modified the buried layers of the CEI compared to 4.2 V aged condition.

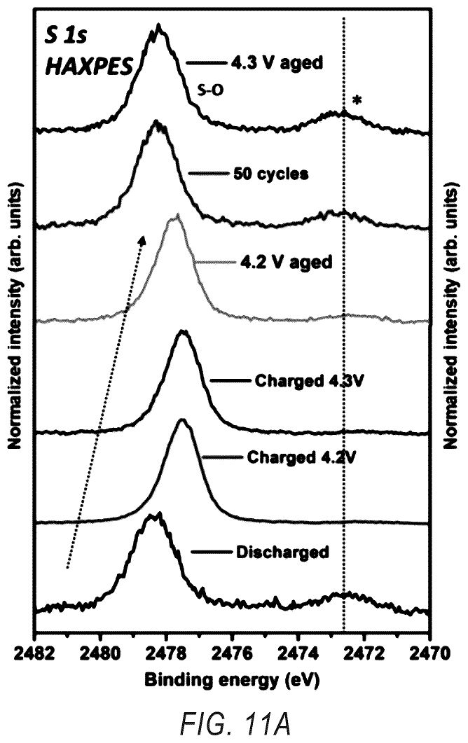

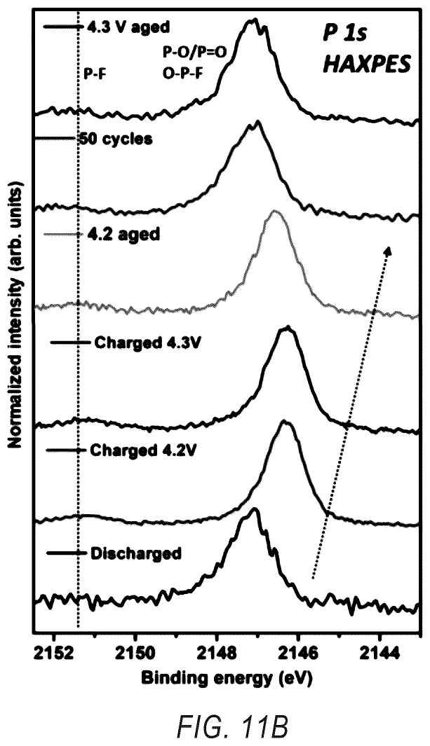

Pursuant to an implementation, the surface passivation contains sulfur species because the sulfur contribution is mainly derived from the TFSI− -anion derived species during CEI formation at high temperature operation. FIG. 11A shows the S 1 s spectra of different states of charge conditions, and the measurement was carried out using 4000 eV photon energy. The lower photon energies (2000 eV) cannot be used to access S 1 s information. A strong signal at about 2478 eV was observed in the S 1 s spectra for all the sample conditions at 4000 eV. Based on the existing literature, this S 1 s signal is assigned to oxygenated sulfur species (S—O) and mainly derived from TFSI− anion parasitic reaction with the electrode surface. This observation clearly confirms that oxygenated sulfur species are in the buried surface of the CEI layer, implying that S—O inorganic moieties are rich in the deeper surface of the CEI layer. Interestingly, the S 1 s peak of discharged states shifted to high energy without change in the peak shape was observed for fully charged conditions, revealing that the shift can be responsible for the changes in the oxygen environment of the sulfur species in the CEI layer. Further, the cycled cathode after 50 cycles almost reversed back to the discharged state which may be due to the changes in the oxygenated sulfur species or after continuous charge-discharge cycling at high temperature. Interestingly, the aged cathode at 4.2 V exhibits almost similar to the charged state, and this behavior is in good agreement with the XAS investigation wherein the 4.2 V cathode was not severely degraded even after aging at 4.2 V for 7 days. Similarly, the cycled cathode at 4.2 V completely reversed back to the discharged state that may be due to the similar surface species formed during the discharged state even after 50 cycles. Since 4000 eV probing is considered for buried surfaces, the negligible changes between 1^{st} discharge and 50^{th} cycles mainly originated from the stability of the CEI species with sulfur composition and also confirms that the buried surface of the CEI layer is rich in inorganic component. As indicated previously, the aged cathode 4.3 V exhibits severe electronic structure variation in the surface region which was primarily due to the TFSI⁻ decomposition on the reactive NMC surface at high temperature operation. In addition, a minute peak at about 2472 eV was observed for all sample conditions, which was assigned to the possible generation of elemental sulfur or S—C species. In the phosphonium ionic liquid, the phosphonium cation is centered with a phosphorous atom, and the P 1 s spectra of the same sample conditions are shown in FIG. 11B.

Similar to sulfur species, the phosphate/fluorophosphate species were assigned to a region of (2149 to 2147) eV. Only limited differences were obtained for different photon energies, implying that a uniform distribution of fluorine-containing species on the NMC cathode at high temperature operation. There are two significant features present in the spectra, A peak around 685 eV is attributed to LiF and another sharp peak at 688 eV is attributed mainly to the PVDF binder and CFx contribution. Compared to 2000 eV, deeper probing at 4000 eV for 50 cycles, aged at 4.3V and 4.2 V, 1^{st} charged and discharged samples have similar contribution of LiF species, indicating that LiF is uniform in the deeper region of the surface layer, In the 2000 eV, the sample conditions exhibit relatively different magnitudes of LiF species, confirming that the LiF species is not strongly adhered to the surface of the NMC in the surface region. Similarly, LiF-rich species were observed in deeper surface layers formed through carbonate electrolytes at extreme temperature conditions.

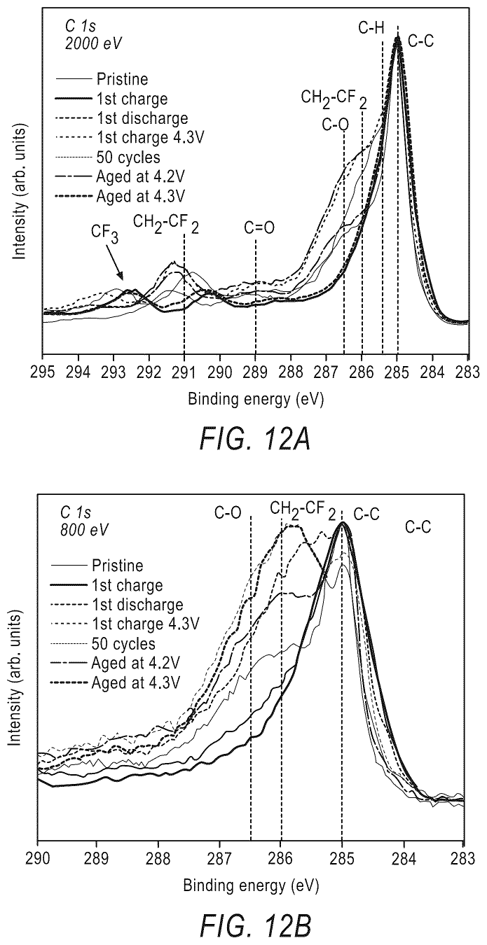

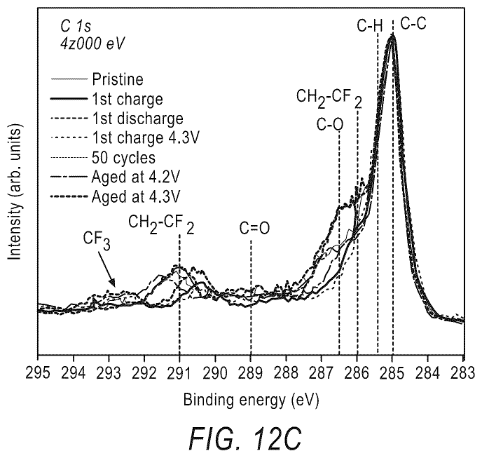

To further understand the surface layer dynamics, the C 1 s spectra were measured for different cycling conditions including pristine, 1^{st} charged and discharged, cycled, and aged cathodes at 4.2 and 4.3 V (FIGS. 12A-12C). Similar to previously mentioned XPS core lines, the C 1 s spectra were measured at photon energies of 800 eV, 2000 eV and 4000 e V to understand the depth-dependent chemistry of the carbon species in the CEI layer. This depth-dependent probing confirms the nature of the CEI whether organic-rich or inorganic species in the different depth levels. Based on the obtained carbon signals, the C 1 s signals can be divided into two regions: bulk C signal and surface organic component from the CEI species. In all the C 1 s spectra, a strong peak at 285 eV is assigned to the C—C signal which originated from the C65 conductive carbon. Other than the C65 signal, large differences between the different photon energies are observed for all the state of charge conditions. In general, the peak at about 285 eV is identified as (C—C/C—H) conductive carbon and hydrocarbon species, whereas the peaks at higher binding energies correspond to oxygenated carbon species, especially C—O species, and C—F species in the surface of the NMC532 cathode material. In general, C65 used in the electrode composite is stable, and the relative intensity of organic species and C65 peaks can be used to qualitatively understand the CEI layer thickness and depth-dependent heterogeneities at different photon energies. As expected, the contribution of the organic species is high at surface-sensitive photon energies (Surface sensitivity: 800 eV>2000 eV>4000 eV), thereby conveying that the organic-rich CEI is rich in the surface-sensitive region compared to the buried surface of the CEI layer (FIG. 12B). In the organic portion of the C 1 s spectra, the possible peak positions are identified as PVDF binder (≈286 eV), carbon-oxygen in different forms such as C—O, C═O. When comparing the C1 spectra in all the photon energies (FIGS. 12A-12C), it is clearly seen that the fully charged cathode at 1^{st} cycle exhibits relatively negligible surface organic species, In addition, the pristine state of the cathode exhibits a shoulder at about 286.5 V and a peak at 291 eV which originate from the surface carbonates and PVDF signals, respectively.

However, limited surface species in the charged conditions in all the depth levels is mainly due tothe electrochemical removal of the carbonate layer from the NMC surface regions. Surprisingly, the additive (DFOB−) anion and salt anion TFSI− species are responsible for initial CEI formation but the CEI formation is not thick enough to fully passivate the surface at 1^{st} charged condition. On the other hand, all other species show a surface layer build-up, and the organic content is increasing as the photon energy decreases. More specifically, the cycled cathode after 50 cycles shows high organic content due to the surface layer formation through ionic liquid decomposition and additive anion degradation from the continuous electrochemical reactions at extremely high temperature battery operation. Even though the ionic liquid is thermally stable, the electrochemical interaction between the ionic liquid and reactive cathode materials at high temperatures is not favorable. However, surface film forming additives form a passivation through oxidative decomposition, thereby protecting the surface from degradation. Pursuant to an implementation, LiDFOB salt was used to possibly passivate the NMC surface through electrochemical oxidative decomposition, implying that this phenomenon also contributes to the surface layer build-up during continued charge-discharge cycles from additional parasitic reactions of ionic liquid species. At 800 eV, the aged cathodes consist of organic species similar to cycled conditions, indicating that the high temperature aging significantly modifies the CEI species through parasitic products of ionic liquid species and additive decomposition products (FIG. 12B).

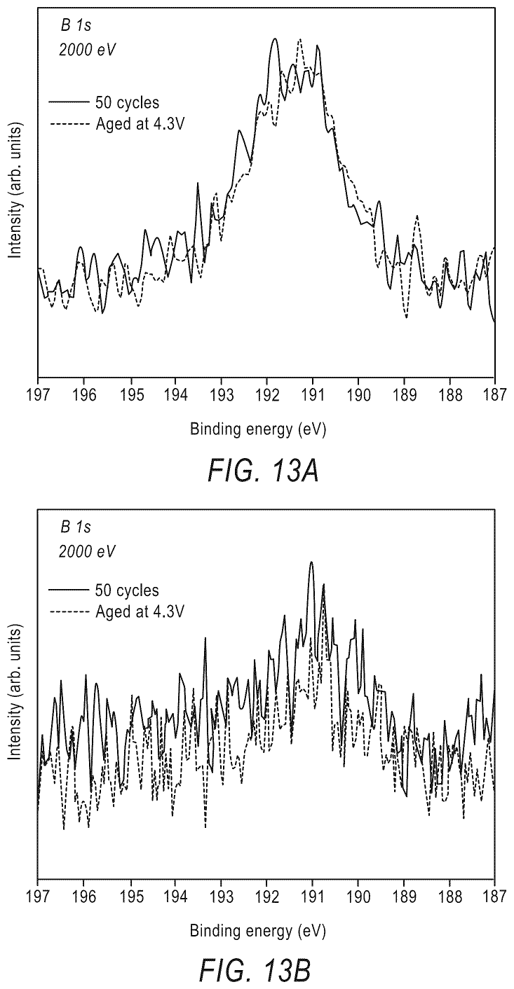

However, the organic features of the aged cathode at 4.2 V slightly diminished in the deeper region due to the less organic content in the buried surface of the material. However, the aged cathode at 4.3 V exhibits almost similar carbon signal similar to cycled cathode, implying that the high voltage aging of 4.3 V leads to significant parasitic reaction and continuous decomposition species forming a CEI layer rich in organic species in the surface similar to the cycled cathode after 50 cycles. This behavior confirms that the repeated cycling also contributes to surface layer buildup, but the surface layer is also formed during the aggressive aging reaction even after the initial charge cycles. To support this observation, the surface layer passivation was further confirmed with the B 1 s signal at different depth levels. FIGS. 13A-13 B shows the B 1 s HAXPES spectra of cycled and 4.3 V aged conditions at two different photon energies (2000 eV and 4000 eV). From the different depth levels, it is seen that the B 1 s signal is rich in the near-surface regions compared to deeper surface and extreme surface regions, indicating that the boron species from DFOB− anion decomposition passivated the NMC cathode surface and the boron species are found rich in intermediate level of the CEI layer formed on top of the NMC532 at high temperature operation.

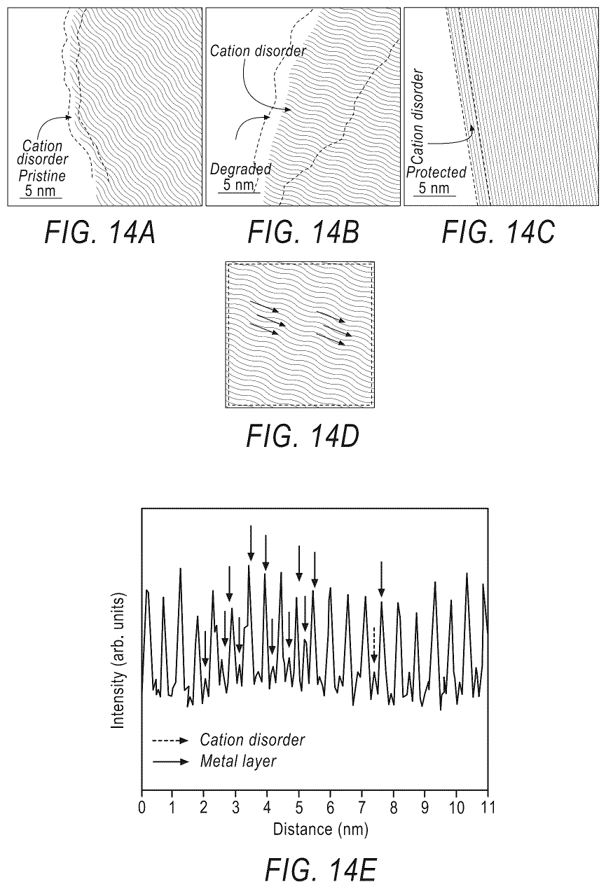

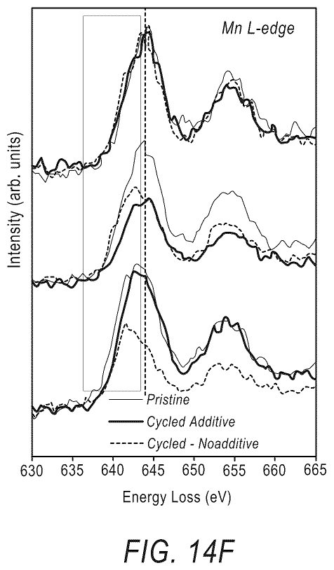

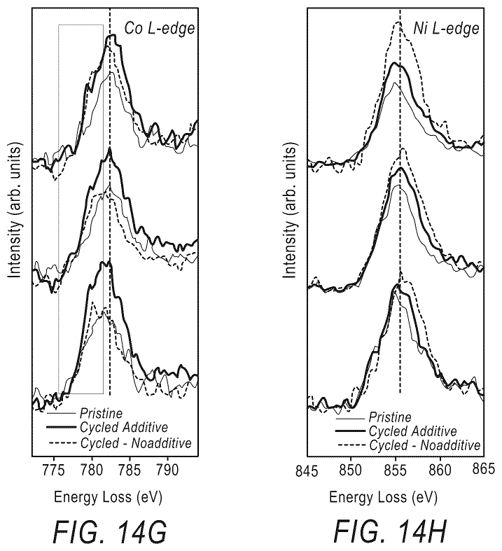

After identifying the spectral features, the nanoscale surface structure was investigated using STEM combined with Electron Energy Loss Spectroscopy (EELS) analysis. As shown in FIGS. 14A-14H, the layered NMC cathode particle was visualized by atomic resolution HAADF-STEM imaging where the layers are sandwiched between two transition metal layers through oxygen stacking along the c-axis. A thin layer of cation disorder was observed in pristine cathode which is common in NMC family oxides, and this thin layer of cation disorder varies as Ni content further increases. In general, Li loss in the specific crystal surface originated from synthesis and surface oxygen loss mechanisms. The Li vacancy created due to Li loss can be occupied by Ni cations from the transition metal layer because Ni²⁺ and Li⁺ sizes are similar in the octahedral coordination, leading to anti-site disorder, in other words, cation disorder. Apart from the thin cation disorder layer, the pristine cathode shows no cation mixing in the bulk of the materials. On the other hand, the cation-disordered region has progressed significantly in the cycled cathode particle using ionic liquid at 100° C., without film-forming additives. The enlarged region is shown in FIG. 14D, where the Li slabs are filled with bright spots implying that severe surface reconstruction occurred because of parasitic interaction between ionic liquid species and reactive NMC cathode surface. In general, surface reconstruction progresses through phase transformation of layered to spinel/rock salt formation when the cathode particle is cycled at high voltage and extreme temperature in carbonate-based conventional Li-ion cells. Fundamentally, the transformation of layered to spinel is known to occur when ¼ of transition metals migrate to the Li layer, leading to a cubic symmetry that forces Li cations into TM vacant sites. On the other hand, transition metal cations occupy the Li layer, but both the transition metal and Li cation are intermixed in the same layer. Further, the surface reconstruction was evaluated by a line profile derived from FIG. 14B, revealing the occupations of the Li layer by transition metals on the surface and near surface of the cathode material. The nanoscale degradation certainly affects the intercalation behavior due to poor Li diffusivity of the disordered layer, surface layer build-up, and impedance growth.

Similarly, parasitic reaction between ionic liquid and NMC cathode surface modified the reactive surface of the cathode particles by creating anti-site defects in the surface and subsurface of the cathodes. This cation disordered layer is relatively denser compared to pristine cathode surface, consistent with the NMC cathodes cycled in carbonate electrolytes at extreme conidiations such as high voltage and high temperature electrochemical reactions. The modified surface lattice structure directly affects the electrochemical performance due to changes in the chemical homogeneity and composition of the cathode surface withal. In another comparison, the NMC532 cathode was cycled with additive exhibits relatively less surface reconstruction similar to pristine cathode. This observation proves that reducing direct contact between cathode surface and ionic liquid by a CEI can reduce parasitic reaction and further surface recontraction process to some extent. However, ageing measurements after fully charged state at high temperature accelerated parasitic reaction that reduced Ni oxidation states near the surface and near-surface regions and also Mn and Co surface reduction, confirming previously through soft X-rat spectroscopy measurements (FIGS. 7A-7B and 8A-8B). Therefore, it suggests that the CEI is protecting the surface to some extent through additives but the aggressive electrochemical conditions forcing the ionic liquid species, especially anions oxidizing on top of the charged cathode surface and releasing electrons to reduce the high valent cations such as Ni⁴⁺, Mn⁴⁺, Co³⁺ in the NMC cathode at high state of charge conditions, The transition metal reduction phenomenon observed through sXAS also can support this claim that can be correlated to the changes in the transition metal composition in the surface reconstructed layer. Overall, the changes in the chemical composition on the surface region could be the reason for constant capacity fade even after protecting the cathode with additives, but it is the obvious reason for the unprotected cathode exhibiting poor performance proved also with other pyrrolidinium ionic liquids. So far, the obtained results challenge the ionic liquid stability and its surface dependent reactivity against oxides, especially NMC cathodes. From the results, we can derive a conclusion that the ionic liquids are thermally stable but the electrochemical interaction and their ability to modify reactive NMC surface is highly dependent on various factors such as ionic liquid anions, cations and other cycling conditions. In order to examine transition metal composition at the vicinity of the NMC particle surface (disordered layer), we analyzed the cathode with different conditions using spatially resolved EELS measurements.

Previously analyzed sXAS is an average ensembled spectra that helped us to analyze transition metal oxidation at different depth levels, but this EELS measurement is a spatially resolved measurement process to directly correlate between disordered region and chemical composition. All EELS measurements observed in FIGS. 14A-14H were collected along the 003 Li diffusion channel. In general, denser surface reconstruction has been observed in the cathode cycled in carbonate electrolytes, indicating that the lithiation extraction along the Li diffusion channel is also one of the reasons for the surface specific cation disorder compositions. In carbonate electrolyte studies, it was proven that the 003-plane surface is prone to degradation during extensive cycling at high voltage, consistent also with computational studies. Therefore, comparing the same surface regions for EELS is ideal for correlating different sample conditions. EELS line scan was performed up to 12 nm from the surface along the Li diffusion channels. EELS spectra at different distances from the surface were extracted from the line scan profile with 3 nm integration width. The EELS data shown in FIGS. 14F, 14G and 14H correspond to spectral information from the 3 nm integration width within the spectra at different distance from the surface (3 nm, 5 nm, and 10 nm).

As shown in FIG. 14F, Mn L edge EELS spectra exhibit low energy shifts, especially for the cathode cycled without any additives. This observation clearly confirms the cation disordered layer and its chemical inhomogeneity of the transition metal caused by severe parasitic reaction between ionic liquid species and cathode surface. On the other hand, pristine and the cathode cycled with additive exhibit relatively less low-energy shifts, indicating the direct correlation between cation disordered layer and transition metal reduction phenomenon. Further, the Co L-edge spectra displays slight shift of the cycled cathode without additive, extracted from the 5 nm region from the surface. This confirms that the cation disordered layers possess mixture of spinel and rock salt phase transformation. In general, the rock salt phase mainly consists of Ni 2+, Mn2+and Co 2+ species compared to the spinel phase with Ni²⁺, Mn⁴⁺ and Co³⁺. Observing relatively different transition metal composition is mainly due to the chemical inhomogeneity in the disordered layer corresponding to spinel and rock salt mixture. Further, based on the Ni L₃ spectra, Ni oxidation state remained at pristine oxidation state due to limited change in the Ni peak shifts at different sample conditions. However, Ni plays a major role in creating anti-site disorder (cation disorder) and Ni is the driving force for spinel/rock salt phase transformation. Fundamentally, the vacant Li sites created by surface Li loss are available for anti-site defects whereby Ni cations from the metal layer can migrate to Li layer due to the similar size of Ni 2+and Li+. In addition, the similar size effect can possibly promote interplane migration of Ni cations to Li layer during repetitive reactions, leading to relatively lower formation energy of Li/Ni exchange as compared to Li/Mn and Li/Co exchange. Further, the intraplane migration of Ni cations in the Li layer to surface can also occur due to anti-site Ni cations possessing low energy for this intraplane transportation, leading to surface densification or surface reconstruction. This gives rise to the surface reconstruction that is relatively higher for the direction along the Li diffusion channels.

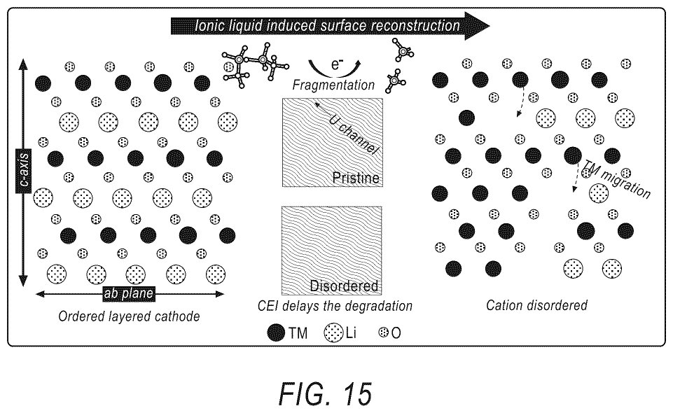

Also, the surface reconstruction layer (cation disordered region) in the STEM imaging is visually low compared to the observation of transition metal reduction spectra collected in the region, suggesting that chemical inhomogencities are not only in the cation disordered regions but also progress towards the deeper regions from the surface of the cathode particle. As shown in FIG. 15, the cation disordering process is a degradation mechanism that affects the Li intercalation, diffusivity, and surface layer buildup. Based on the experimental results, we believe that the ionic liquid species are slowly oxidizing on top of the cathode surface at high state of charge, and slow release of electrons from the ionic liquid fragmentation process is trying to reduce the metal cations facilitating further metal migration from metal layer to lithium layer. This gradual build-up is progressing from the surface to subsurface of the materials and the magnitude of the process may vary based on the ionic liquid species anion-cation combinations and NMC cathode compositions. The mixture of spinel and rock salt surface reconstructed layer affects the Li intercalation properties if the electrolyte doesn't have CEI forming additives. The CEI formation is delaying this degradation process by protecting the reactive cathode surface from ionic liquid attack. The observed cation disordering process formed just after the 15 cycles of continuous charge discharge cycles in the potential region of (2.8 to 4.2) V vs. Li/Li+, whereas the similar surface reconstruction process occurs in carbonate electrolyte after extensive cycling of at least more than 100 cycles and at a high upper cutoff voltage of 4.7 V and above.

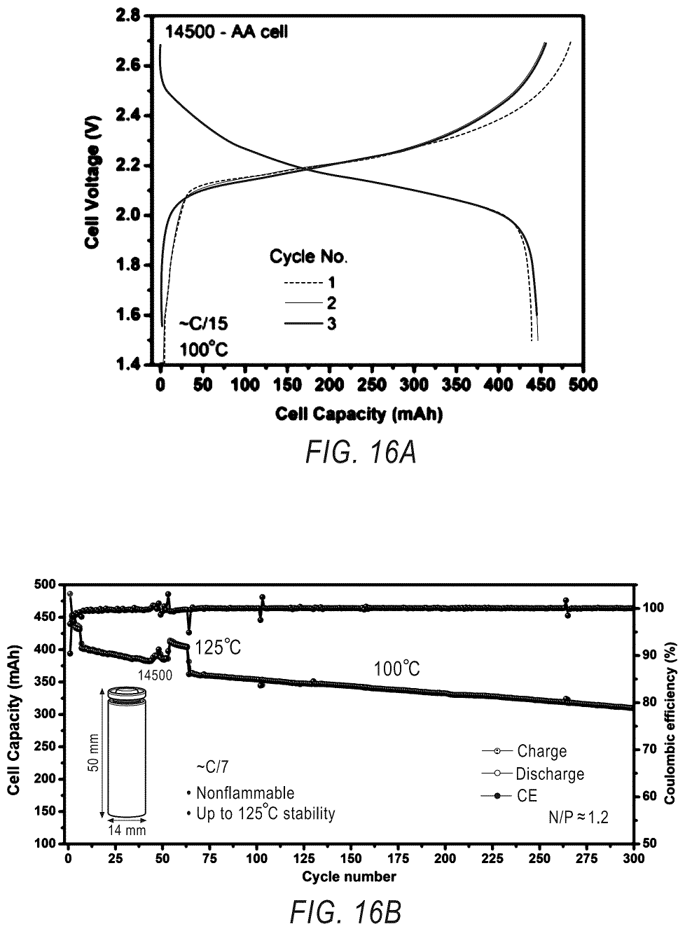

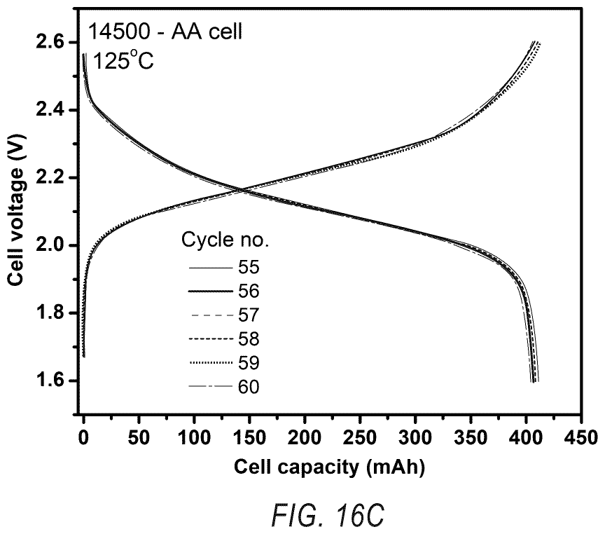

Pursuant to an implementation, the negative to positive electrode capacity ratios were adjusted to ≈1.2. As shown in FIGS. 16A-16B, the fabricated cell exhibits a reversible cell capacity value of 450 mAh and an initial CE of 90%. After the first few cycles, the CE value increases to >99.5% at 50 mA charging current (≈C/8 rate) and almost 100% depth of discharge. FIG. 16B shows cyclic stability of the cell operated at 100° C. and a few intermediate high temperature operations at 125° C. Even after cycling at 125° C., the cycling test shows stable profile with a capacity retention of around 87% (starting from C/8 rate at 5^{th} cycle) after 200 cycles. This observation clearly confirms the stability (temperature and electrochemical) of the ionic liquid composition, and its stable interface protects the NMC cathode surface from degradation for stable electrochemical cycling. Even though the 99.5% CE and 450 mAh cell capacity are lower than the commercial level room temperature cells in the same format, the preliminary observation strengthens the possibility of developing nonflammable high temperature rechargeable battery with wide variety of thermally stable ionic liquid electrolytes in various commercial cell formats. Pursuant to an aspect, the cell capacity of battery 100 can be improved further by increasing high loading cathode and alternative high-capacity anodes for competing with real life applications. FIG. 16C shows voltage profiles of an AA cell with the chemistry and structure of the present disclosure operated at 125° C.

Pursuant to an implementation, the phosphonium based ionic liquid electrolyte was optimized with 0.5 mol/L LiTFSI and 0.5 w/v % LIDFOB film forming additive for high temperature electrochemical performance. The fabricated coin cells performed 50 continuous charge-discharge cycles with gradual capacity fade, and high temperature (100° C.) electrochemical reactions of lithiation and delithiation in NMC532 cathodes affect the interfacial properties (even at a relatively low extraction ratio (≈65%) and valence state variation in different depth levels from the surface of the cathode particle. Depth-dependent soft X-ray spectroscopy measurements confirmed the reduction of Ni, as well as a slight reduction of Co and Mn, propagating from surface to bulk at 4.3 V vs Li/Li⁺. Furthermore, O K-edge TEY and FY measurements confirmed reversible variations in covalency between the transition metal and the oxygen environment, as it was well reflected in the depth-dependent O K-edge spectra under different state of charge cathode conditions. Further, HAXPES measurement revealed the chemical heterogencities of CEI formed on the NMC cathode surface at high temperature electrochemical reactions. Even though film-forming additives are present in the ionic liquid electrolyte (0.5 w/v % LIDFOB), the CEI formation is not too thick as was confirmed by probing deeper using high energy X-ray photon. The CEI surface region is mainly composed of organic species and the deeper surface is rich in inorganic components such as Li—F, S—O, and P—O species. In addition, boron species were found in the CEI layer, implying that the boron contribution is derived from additive salt decomposition.

Compared to other inorganic species, the observed boron species are rich in the near-surface region compared to the buried layers of the CEI. Even though the CEI protects the surface from high temperature degradation, repetitive cycling and high temperature aging severely degraded the surface even at the moderate voltage of 4.3 V vs. Li. Based on the aberration corrected STEM analysis, severe surface degradation in the NMC cathode was observed due to cation disorder caused by a surface reconstruction phenomenon. The degradation process occurred in cathodes cycled at a moderate upper cutoff voltage of 4.2 V vs Li/Li+ without the use of any film forming additives. Also, the EELS measurements confirmed the presence of surface reduction of Co and Mn in the disordered region compared to bulk of the material. These observations suggest that the parasitic reactions release electrons through anion oxidation to cathode surface, leading to surface reconstruction with cation disordered surfaces at such a low voltage of 4.2 V vs Li. Therefore, these results strengthen the importance of using high temperature additives for a CEI film when using thermally stable ionic liquids to enable reversible lithiation-delithiation reactions of NMC family cathodes at high temperature. As a proof of concept, the reversible electrochemical performance of NMC532/LTO full-cell chemistry was demonstrated in a practical cylindrical cell format, delivering a capacity of 450 mAh at 100° C. The results highlight the significant challenges associated with the interaction between ionic liquids and NMC cathodes.

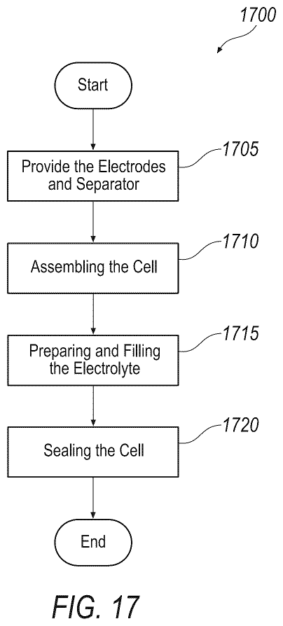

Referring to FIG. 17, a method 1700 for manufacturing a high-temperature rechargeable lithium-ion battery capable of operating at 100° C. and beyond is shown. At step 1705, the cathode 102, anode 104, and separator 106 are provided. The cathode 102 may be formed using LiNi_{0.5}Mn_{0.3}Co_{0.2}O₂ (NMC532) as the active material. The anode 104 may be formed using Li₄Ti₅O₁₂ (LTO). The cathode may be prepared by mixing NMC532, a conductive carbon additive, and a binder in a predefined weight ratio, dispersing the mixture into a solvent to form a slurry, and coating the slurry onto a conductive substrate such as carbon-coated aluminum foil. Similarly, the anode may be prepared by mixing LTO with a conductive carbon additive and a binder, dispersing the mixture into a solvent to form a slurry, and coating the slurry onto a copper foil. The electrodes may be dried at an elevated temperature (e.g., 100° C.) to remove residual solvent. A polypropylene-based commercial monolayer separator may be used, which provides thermal stability and compatibility with the phosphonium-based ionic liquid electrolyte. The separator 106 may be prepared using a high-temperature material, such as polypropylene or quartz membrane. The separator may be treated to enhance its wettability and porosity, which ensures effective electrolyte infiltration and ionic conductivity. The separator material is cut into the required size and shape (e.g., rectangular or cylindrical) to match the electrode dimensions and cell form factor.

At step 1710, the cathode 102, anode 104, and separator 106 are positioned and assembled into a cell housing, such as a stainless steel cylindrical case. For an AA-size (14650) cylindrical cell, the cathode, anode, and separator may be wound into a jelly roll configuration, ensuring uniform contact between the electrodes and separator. The wound electrode-separator assembly is placed inside the cylindrical cell case, with the cathode and anode tabs positioned accordingly for external electrical connection. The assembly method can be extended to different form factors, including 18650, 21700, 4680, and pouch cells, with adjustments in electrode dimensions and winding techniques.

At step 1715, a phosphonium-based ionic liquid electrolyte is prepared, comprising a thermally and electrochemically stable phosphonium ionic liquid, a lithium-conducting salt (e.g., LiTFSI), and a film-forming additive (e.g., LiDFOB). The electrolyte formulation is designed to remain nonflammable and stable at 100° C. and beyond. The prepared nonflammable electrolyte is filled inside the assembled cell under an argon-filled glovebox to prevent contamination. The nonflammable electrolyte is filled inside the case to allow for the electrolyte to wet and contact the anode and the cathode. After electrolyte filling, the cell may be subjected to vacuum-assisted soaking for a predetermined duration (e.g., 2 minutes) to ensure thorough electrolyte infiltration into the electrode-separator assembly.

At step 1720, the cell is hermetically sealed using a cover, ensuring an inert and moisture-free environment inside the battery. Sealing methods may include laser welding, crimping, or heat sealing, depending on the cell format.

In some implementations, the sealed cell undergoes formation cycling to stabilize the solid-electrolyte interphase (SEI) on the anode and the cathode-electrolyte interphase (CEI) on the cathode. The phosphonium-based ionic liquid electrolyte facilitates the formation of a robust SEI and CEI, preventing electrolyte decomposition and enabling long-term cycling stability at high temperatures. The cell may be subjected to galvanostatic cycling, electrochemical impedance spectroscopy (EIS), and dQ/dV analysis to confirm stable performance at elevated temperatures.

This disclosure uses phosphonium ionic liquid cation and can include multiple anion combinations including fluorosulfonimide, cyanoborate, and other borate-based anions. Pursuant to an implementation, the phosphonium ionic liquid may include derivatives and combinations of different family ionic liquids, including but not limited to nitrogen-based pyrrolidinium, piperidinium, etc. Also, the lithium salt is not only limited to LiTFSI, but this electrolyte chemistry can also accommodate other lithium salts such as lithium perchlorate (LiCIO₄) lithium bis(fluorosulfonyl)imide (LiFSI), lithium bis(oxalato)borate (LiBOB), 4,5-dicyano-2-(trifluoromethyl)imidazolide (LiTDI), and lithium tetrafluoroborate (LiBF₄). In addition, this electrolyte combination using film forming additive is not only limited to LiDFOB, but the additive component can also be from molecules (carbonates, borates, phosphates) such as lithium difluoro(bisoxalato)phosphate (LiDFBP), fluoroethylene carbonate (FEC), and trimethyl silyl borate (TMSB). Lithium salt contraction can be 0.2-1 M, and additive concentration can be 0.1-5 wt %, depending on the composition.

The disclosed electrolyte chemistry is not only limited to NMC532/LTO chemistry, but this can also be extended to other NMC or LiFePO₄ (LFP) family cathodes as well. The anodes including pure LTO, and carbon coated LTO, and high energy Li metal or Si anodes can be utilized for this chemistry. The high temperature cell chemistry utilizes polypropylene commercial monolayer separator, but this can be modified with reduced thickness as well. This technology was currently validated with AA cell format, but this technology can also be applied to different cell sizes such as 18650, 21700, 30700, 4680 and pouch cell formats.

Accordingly, there is disclosed a new electrolyte combination to be used in developing high temperature and rechargeable Li-ion batteries for industrial applications operated at extreme environment.

Applications include, but are not limited to, portable electronics, high temperature sensor applications, space applications, Oil and Gas drilling, military applications, Measuring While Drilling (MWD) and Logging While Drilling (LWD).

Some advantages pertain to this disclosure include:
A) This technology utilizes nonflammable phosphonium based ionic liquid electrolyte that allows us to tune its properties with huge array of ionic liquid electrolyte composition with one or more Li conducting salts and salt/solvent additives.
B) The optimized electrolyte composition is compatible with cell chemistry comprises high capacity NMC (LiNiₓMnᵥCo_{z}O₂, where x+y+z=1) cathodes and LTO anode.
C) This cell chemistry can deliver high energy density and capacity compared to LFP/LTO cell chemistry.
D) This disclosure can be extended to batteries with NMC or LFP family cathodes and Lithium metal anodes.
E) The technology delivers excellent battery safety due to its non-flammable electrolyte.
F) This high temperature battery technology can be recharged continuously at extreme high temperature conditions, and this disclosure will lead to reduce electronic waste by replacing primary battery technologies in various downhole industrial operations.

When introducing elements of various embodiments of the disclosed materials, the articles “a”, “an”, “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments. While the preceding discussion is generally provided in the context of Lithium-ion batteries, it should be appreciated that the present techniques are not limited to such limited contexts. The provision of examples and explanations in such a context is to facilitate explanation by providing instances of implementations and applications. The disclosed approaches may also be utilized in other contexts or configurations.

All matter contained in the above description or shown in the accompanying drawings shall be interpreted as illustrative only and not limiting. Changes in detail or structure may be made without departing from the present disclosure.

While the disclosed materials have been described in detail in connection with only a limited number of embodiments, it should be readily understood that the embodiments are not limited to such disclosed embodiments. Rather, that disclosed can be modified to incorporate any number of variations, alterations, substitutions, or equivalent arrangements not heretofore described, but which are commensurate with the spirit and scope of the disclosed materials. Additionally, while various embodiments have been described, it is to be understood that disclosed aspects may include only some of the described embodiments. Accordingly, that disclosed is not to be seen as limited by the foregoing description but is only limited by the scope of the appended claims.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary. Further, the use of “at least one of” is intended to be inclusive, analogous to the term and/or. As an example, the phrase “at least one of A, B and C” includes A only, B only, C only, or any combination thereof (e.g. AB, AC, BC or ABC). Additionally, use of adjectives such as first, second, etc. should be read to be interchangeable unless a claim recites an explicit limitation to the contrary.

What is claimed:

1. A high-temperature rechargeable lithium-ion battery, comprising:
a cathode;
an anode;
a separator disposed between the cathode and the anode; and
an electrolyte composition comprising:
a phosphonium ionic liquid;
a lithium conducting salt; and
a film-forming additive;
wherein the electrolyte composition is thermally stable and electrochemically stable, enabling the rechargeable lithium-ion battery to operate at temperatures above 100° C.

2. The high-temperature rechargeable lithium-ion battery of claim 1, wherein the cathode comprises a material selected from a group consisting of LiNiₓMn_{y}Co_{z}O₂, where x+y+z=1, LiCoO₂, LiMn₂O₄, LiNiO₂, LiFePO₄, and combinations thereof.

3. The high-temperature rechargeable lithium-ion battery of claim 1, wherein the anode comprises a material selected from the group consisting of Li₄Ti₅O₁₂ (LTO), graphite, silicon, tin, lithium metal and combinations thereof.

4. The high-temperature rechargeable lithium-ion battery of claim 1, wherein the separator comprises a material selected from a group consisting of polyethylene, polypropylene, ceramic-coated separators, and combinations thereof.

5. The high-temperature rechargeable lithium-ion battery of claim 1, wherein the phosphonium ionic liquid comprises a combination of cations and anions selected from a group consisting of fluorosulfonimide, cyanoborate, and phosphate/borate-based anions.

6. The high-temperature rechargeable lithium-ion battery of claim 1, wherein the lithium conducting salt is selected from a group consisting of lithium bis(trifluoromethanesulfonimide) (LiTFSI), lithium perchlorate (LiCIO₄), lithium bis(fluorosulfonyl)imide (LiFSI), lithium bis(oxalato)borate (LiBOB), 4,5-dicyano-2-(trifluoromethyl)imidazolide (LiTDI), and lithium tetrafluoroborate (LiBF₄).

7. The high-temperature rechargeable lithium-ion battery of claim 1, wherein the film-forming additive is selected from a group consisting of lithium difluoro(oxalato)borate (LiDFOB), lithium difluoro(bisoxalato)phosphate (LiDFBP), fluoroethylene carbonate (FEC), and trimethyl silyl borate (TMSB).

8. The high-temperature rechargeable lithium-ion battery of claim 1, wherein the lithium conducting salt has a concentration ranging from 0.2 M to 1 M or localized high concentrated conditions.

9. The high-temperature rechargeable lithium-ion battery of claim 1, wherein the film-forming additive has a concentration ranging from 0.1 wt % to 5 wt %.

10. An electrolyte composition for a lithium-ion battery cell operable at high temperatures, comprising:
a phosphonium-based ionic liquid;
at least one lithium-conducting salt including at least one of lithium bis(trifluoromethanesulfonyl)imide (LiTFSI), lithium bis(fluorosulfonyl)imide (LiFSI), lithium tetrafluoroborate (LiBF₄), lithium bis(oxalato)borate (LiBOB), lithium perchlorate (LiClO₄), and lithium 4,5-dicyano-2-(trifluoromethyl) imidazolide (LiTDI); and
at least one film-forming additive including at least one of lithium difluoro(oxalato)borate (LiDFOB), lithium difluoro(bisoxalato)phosphate (LiDFBP), fluoroethylene carbonate (FEC), and trimethylsilyl borate (TMSB);
wherein the electrolyte composition is nonflammable and enables lithium-ion battery operation at temperatures above 100° C.

11. The electrolyte composition of claim 10, wherein the lithium-conducting salt has a concentration ranging from 0.2 M to 1 M or localized high concentrated conditions.

12. The electrolyte composition of claim 10, wherein the film-forming additive has a concentration ranging from 0.1 wt % to 5 wt %.

13. A method of making a rechargeable lithium-ion battery, comprising:
providing an anode and a cathode;
positioning the anode and the cathode inside a cell case, wherein the anode and cathode are separated by a separator;
filling the inside of the cell case with a nonflammable electrolyte so that the electrolyte wets and contacts the anode and the cathode; and
sealing the cell case;
wherein the nonflammable electrolyte includes a thermally and electrochemically stable ionic liquid, at least one lithium conducting salt, and at least one film forming additive.

14. The method of claim 13, wherein the thermally and electrochemically stable ionic liquid includes a phosphonium-based ionic liquid.

15. The method of claim 13, wherein the anode comprises a material selected from a group consisting of Li₄Ti₅O₁₂ (LTO), graphite, silicon, tin, and combinations thereof.

16. The method of claim 13, wherein the cathode comprises a material selected from a group consisting of LiNiₓMn_{y}Co_{z}O₂, where x+y+z=1, LiCoO₂, LiMn₂O₄, LiNiO₂, LiFePO₄, and combinations thereof.

17. The method of claim 13, wherein the at least one lithium conducting salt includes at least one of lithium bis(trifluoromethanesulfonyl)imide (LiTFSI), lithium bis(fluorosulfonyl)imide (LiFSI), lithium tetrafluoroborate (LiBF₄), lithium bis(oxalato)borate (LiBOB), lithium perchlorate (LiClO₄), and lithium 4,5-dicyano-2-(trifluoromethyl)imidazolide (LiTDI).

18. The method of claim 13, wherein the at least one film forming additive includes at least one of lithium difluoro(oxalato)borate (LiDFOB), lithium difluoro(bisoxalato)phosphate (LiDFBP), fluoroethylene carbonate (FEC), and trimethylsilyl borate (TMSB).

19. The method of claim 13, wherein the lithium-conducting salt has a concentration ranging from 0.2 M to 1 M or localized high concentrated conditions.

20. The method of claim 13, wherein the film-forming additive has a concentration ranging from 0.1 wt % to 5 wt %.
